(19) United States
(12) Patent Application Publication
(10) Pub. No.: US 2003/0236735 A1
(43) Pub. Date: Dec. 25, 2003

(54) Method and apparatus for facilitating funding of trade

(75) Inventors: Alexander Charles Croxall Brennan, Ipswich (GB); Michael Stephen Kaufman, London (GB); William Stuart Morrison, Ipswich (GB)

Correspondence Address: MORGAN, LEWIS & BOCKIUS LLP, 1701 MARKET STREET, PHILADELPHIA, PA, 19103-2921, US

(73) Assignee: EZD Limited

(21) Appl. No.: 10/175,704

(22) Filed: Jun. 20, 2002

(51) Int. Cl. G06F 17/60

(52) U.S. Cl. 705/37

(57) ABSTRACT

The present invention relates to a method and apparatus for providing non recourse funding of trade in goods during transit. In the method of the invention risks are allocated to decrease the cost of trade finance. A Funding Bank provides non recourse funding based upon various financial commitments received from a Performance Insurer and a Collateral Control Bank. The present invention also relates to a computer system for facilitating trade in goods comprised of a communications network coupled to a logistic data server and a trade management system. The communications network transmits and receives data from parties involved in the funding of trade in goods. The logistic data server calculates a target shipping trajectory and calculates the transactions overall credit worthiness. The trade management system monitors the actual shipping trajectory and determines whether to initiate corrective action when the actual shipping trajectory differs from the target shipping trajectory.

### BACKGROUND OF THE INVENTION

1. Field of the Invention

The present invention relates to a method and apparatus for providing non recourse funding of trade in goods during transit that provides comparable or greater financial security to traditional trade finance products with the convenience of open account trading. The present invention also relates to a Logistics Service Provider (LSP) that integrates logistical and financial services into a single solution that is more efficient and allows the parties involved to make better use of the resources available in such transactions.

2. Description of the Background

In order for a manufacturer of goods to convert finished goods into revenue through the purchase of the goods by a buyer, manufacturers usually need to rely on the assistance of certain third parties, including logistics providers (who ship the goods) and finance providers, such as banks and insurers (who finance and insure the goods to facilitate trade). This process is both costly and inefficient. The LSP of the present invention integrates logistical and financial services into a single solution that allows the parties involved to make better and more efficient use of the resources available in such transactions.

Typically, there are several parties involved in trade transactions through various relationships and contractual obligations. In particular, where international transport of goods is required, the relationships and contractual obligations of the parties involved can be quite complex.

A conventional trade transaction usually involves the transport of goods between the company supplying and shipping the goods (the Shipper) and the company purchasing and receiving the goods (the Consignee). The Shipper and the Consignee make an agreement with one another that the Shipper will supply certain goods to the Consignee at a particular price, and by a particular date. The agreement may be memorialised in a single document such as a contract of supply, or in a set of documents such as an order form sent by the Consignee to the Shipper and an invoice sent by the Shipper to the Consignee.

The terms of such an agreement can take many forms with respect to the distribution of risk between the parties. At one end of the scale are extended open account terms, which pose a high risk for the Shipper and a low risk for the Consignee. In this arrangement, the Consignee pays for goods over a period of time, during which the Consignee has the benefit of possession of the goods. In this arrangement, the Shipper, through receivables on its balance sheet, is assuming the credit risk of the Consignee, including the risk that the Consignee refuses to pay due to a dispute.

At the other end of the scale with respect to distribution of risk, a cash in advance agreement provides a low risk for the Shipper but a high risk for the Consignee. In this case the Consignee pays for the goods before delivery to the final destination (replacing cash on its balance sheet with assets, even though the Consignee is not yet able to exploit the assets) and bears the risks of any problems arising during transportation and with the quality of the goods.

An alternative method of international trade where both parties have a more balanced risk is where a letter of credit is used to shift the credit risk to parties better able to manage such risks. Specifically, credit risk is borne by a bank or other financial institution. In this method, a letter of credit is issued by the Consignee's bank in favour of the Shipper, and is payable once specified documents are presented to the issuing bank. The specified documents may include a bill of lading, an invoice, an appropriate insurance certificate, a certificate of inspection, export licences, and certificates of origin. The letter of credit is secured against the balance sheet of the Consignee. Once issued, the letter of credit is considered to be an asset belonging to the Shipper and as such the Shipper may borrow against the collateral of the letter of credit and these borrowings will appear on its balance sheet. Thus, though the risk is more balanced between parties in this method, it may result in the balance sheets of both the Shipper and the Consignee being encumbered, which is inherently expensive.

Another disadvantage of the use of a letter of credit is the cost of the preparation of the letter of credit. The Shipper must prepare all documents very carefully, because the Consignee's bank may withhold payment even for minor typographical errors. Furthermore, the process is potentially open to fraud because the correct documents may be presented even if the goods have not actually been delivered to the Consignee.

In parallel to, but independent of, the arrangements for finance, the Shipper will arrange transport of the goods. The transport may involve a number of parties, for example, truckers, freight forwarding companies, customs, cargo handlers and shipping lines may all be involved at some stage during the transport. The goods are then transported by the various transporters from the Shipper to the Consignee. Once the goods have been received by the Consignee, or other necessary conditions have been met as specified in the letter of credit, the Consignee, or bank, settles the debt with the Shipper. Of significance during this process, is that the parties involved in finance typically play no active part in, and do not see the process of transport while it is in progress.

There are many risks associated with the processes described above that may cause it to fail so that payment from Consignee to Shipper does not occur as planned. For example, the goods may be delayed, lost, stolen or damaged during transit, the Consignee may not be able to pay, or the Consignee may choose not to pay because the goods are deemed to be defective or otherwise in dispute. Though insurance may be taken out to cover some of the aforementioned risks, coverage is often disjointed. As the trade finance and transport arrangements are made separately, financial credit risks are viewed and covered separately from the risks arising from problems in transit. Yet transit risks have an impact on the cost of financing, (e.g., through the potential impact of delays on the interest costs incurred). Additionally, the transport process is not actively managed to minimize the financial impact despite the fact that there are significant financial risks arising from it.

Finance companies generally lend on the basis of securing a loan against some collateral that the finance company controls and can audit. In the case of letters of credit and other similar trade protocols, the loan is secured against the balance sheet of one or the other or both of the companies involved. In other circumstances, finance companies may lend against the security of inventory stocks provided the stock can be audited and ‘secured’ (e.g. held in a secure warehouse). However, finance companies have traditionally been unwilling to lend against inventory in transit.

While goods are in transit, the performance risk of delivery is at its highest, but monitoring or managing this risk is outside the direct control of both the Shipper and the Consignee. Despite this, they are usually financing this risk from one or both of their equity resources that is, trade finance is secured over the balance sheets of the Shipper and/or the Consignee. Or stated in another way, as a rule in traditional international trade transactions a significant asset, the inventory in transit, is not exploited when arranging finance, and as a consequence finance is either not available or the cost of finance is higher than it might otherwise be.

The only partial exception to this rule, in the case of international shipment by sea, arises in the circumstances where the shipping line issues a bill of lading through which the shipping line takes a lien to the goods to secure payment of the transport freight charges before delivery. In this situation, the inventory is being used to secure finance. However, as the freight charges are on average only 7% of the value of the cargo this is an inefficient use of the value of the collateral (over 90% is unexploited). Moreover, the existence of the lien held by the shipping line is itself an obstruction to more effective use of the collateral as other parties are subject to the shipping line obstructing completion of the shipment in order to receive its payment.

### SUMMARY OF THE INVENTION

The present invention changes the business process outlined above and re-allocates the roles and risks appropriately between parties. The present invention includes a method for facilitating non-recourse funding of trade and goods during transit from a Shipper to a Consignee. In the present invention, three financial institutions are used: a financial institution which provides a guarantee of the consignee's financial performance (Collateral Control Bank); a financial institution which provides a guarantee of the shipper's financial performance (Performance Insurer); and a financial institution which provides funds against the aforementioned guarantees (Funding Bank). The Funding Bank advances at least a portion of payments due to the Shipper under the trade contract, without recourse to the Shipper, upon dispatch of the goods from the Shipper based on the performance insurance and a commitment from a Collateral Control Bank. A transporter of the goods under the trade contract (the Transporter) surrenders any security interest acquired in the goods during transit. Among other features, the business process of the present invention includes the issuance of a commitment, from the Collateral Control Bank, to provide credit protection to the Funding Bank in order to cover risk associated with non-payment by the Consignee of amounts due under the trade contract, upon receipt of the goods by the Consignee.

In accordance with a further aspect, the present invention also monitors the integrity of the supply chain, and checks the contractual integrity of the chain to ensure there are no contractual gaps. Additionally, data relating to the Shipper and the Consignee is stored centrally to allow performance insurance to be arranged on the basis of well understood risks. Such insurance, together with finance for trade, can therefore be arranged at a lower cost than would otherwise be possible. In many instances, without the benefit of the present invention, such insurance and finance for trade may not be available at all.

In accordance with a further aspect of the present invention, a computer system for facilitating trade in goods during transit from a Shipper to a Consignee is comprised of a communications network coupled to a logistic data server and a trade management system, where the communications network couples a plurality of data terminals that transmit and receive data from parties involved in the funding of trade in goods during transit from the Shipper to the Consignee. The logistic data server stores, processes and accesses data received from the data terminals. The logistic data server uses the data to calculate a target shipping scheduling trajectory for the transit of goods from the Shipper to the Consignee based on a planned movement of the goods and to calculate the overall credit worthiness of the transaction. The determination of the credit worthiness of the transaction is based, at least in part, on the credit limit of the Consignee (how much credit is available to the Consignee) and the credit period (how long credit is available to the Consignee).

The trade management system monitors the actual shipping trajectory of the goods during transit from the Shipper to the Consignee and determines whether to initiate corrective action to alter the planned movement of the goods when the actual shipping trajectory differs from the target shipping trajectory by more than a predetermined amount. The determination made by the trade management system as to whether an alteration of the planned movement of the goods should be made, is based, at least in part, on the financial costs involved, the credit risks involved and the potential to avoid disputes. For example, an early delivery of several days in the actual shipping trajectory from the target shipping trajectory may result in additional costs to the Consignee, such as increased storage charges. A delay of several days may similarly result in additional costs to the Consignee if, for example, the Consignee is unable to timely start production of a multi-component product due to a delay in the delivery of the goods being shipped. The delay, together with any additional costs, may also result in the Consignee exceeding its credit limit and/or credit period, thereby increasing the credit risk of the transaction to the Collateral Control Bank.

The financial costs resulting from a delay in the shipment (or early arrival) of the goods if the planned movement of the goods is not altered, may be borne by at least one of the Shipper, Consignee, Performance Insurer, Logistics Service Provider or Funding Bank. The increased financial or credit risk resulting from a delay in the shipment of the goods, may be borne by the Collateral Control Bank. The present invention compares the increased financial costs and risks mentioned above to the cost of taking corrective action to alter the movement of goods in determining whether to implement such corrective action.

The present invention also relates to a Logistics Service Provider (LSP) that integrates logistical and financial services into a single solution that is more efficient and allows the parties involved to make better use of the resources available in such transactions.

The present invention also relates to a system that integrates both logistical and financial elements of the trade flow and changes the business process to re-allocate roles and risks appropriately between parties, thus reducing risks and significantly lowering the cost of finance.

In particular, if the provision of trade finance and logistics is under the control of a single party, then the contractual integrity of the supply chain can be checked to ensure there are no contractual gaps resulting in unnecessary financial risks. Furthermore, if all data relating to the trade flow (both financial and logistics), the Shipper and the Consignee are managed centrally, then such data can be used to allow the full range of financial and transit insurance to be arranged on the basis of well understood risks and ultimately such insurance together with finance for trade can be arranged at a lower cost, than is otherwise possible.

It is a further advantage if the physical integrity of the logistics chain, the progress of the movement, and the current financial risk profile can be monitored in real time, so that the transport operations can be actively managed and optimized in real time to minimize the impact on financial risks.

In accordance with a further aspect, the present invention monitors the physical integrity of the logistics, so that data relating to the physical location and status of the goods can be kept up to date and may be checked regularly by interested parties. The present invention provides a method and system for trade flow management that manages the execution of both the logistical and financial elements of trade actions, reducing the cost of trade flows and make them more secure.

A successful trade transaction between a Shipper and a Consignee requires the performance of a sequence of trade flow steps that ultimately results in the exchange of physical goods for financial value. Each step has an expected duration and an expected success rate or probability of success so that, for the trade transaction as a whole, it is possible to calculate the expected delivery date (e.g., completion of the physical move) and completion date (e.g., completion of the whole transaction including financial payment), and the expected value realized from the trade. The objective of managing the trade flow is to maximize the expected value of the trade. The distinction between the expected value of the trade and the simple invoice value is that the expected value takes into account the likelihood of success and timeliness of the receipt of the payment.

The method and system for trade flow management of the present invention determines, at numerous points throughout the trade flow, whether the performance of the trade flow is still on target to proceed as planned or whether a corrective action needs to be initiated. If the trade flow is still on target, then notification is passed to interested parties of the change in status and no further action is taken allowing the current actions to continue to completion. If the trade flow is no longer on target to complete as planned, the method and system for trade flow management of the present invention queries logistical, financial and trade compliance systems to determine available actions and initiates the action that maximizes the expected value, updating the relevant system values accordingly.

The present invention is thus directed to a method and apparatus for providing non-recourse funding of trade in goods during transit that provides comparable or greater financial security to traditional trade finance products with the convenience of open account trading. The present invention addresses the problems cited above, through the services of a Logistics Service Provider that integrates logistical and financial services into a single solution that is more efficient and allows the parties involved to make better use of the resources available in such transactions.

### BRIEF DESCRIPTION OF THE DRAWINGS

For the present invention to be clearly understood and readily practiced, the present invention will be described in conjunction with the following figures, wherein like referenced numerals are employed to designate like parts or steps, are incorporated into and constitute a part of this specification, and illustrate embodiments of the invention that together with the description serves to explain the principals of the invention. In the drawings:

FIG. 1 shows a diagram of a conventional method of funding a trade transaction involving transport of goods between a Shipper and a Consignee according to the prior art;

FIG. 2 is flow chart illustrating the steps involved in a typical transport of goods according to the prior art;

FIG. 3 diagrams a method of facilitating the finding of a trade transaction and the contractual relationships of the parties involved in such funding, according to the present invention;

FIG. 4 is a diagram of the architecture of a data processing system, or logistic data server, according to the present invention;

FIG. 5 is a diagram of the Shipper data store according to the present invention, which is stored on the logistic data server of FIG. 4;

FIG. 6 is a diagram of the Consignee data store according to the present invention, which is stored on the logistic data server of FIG. 4;

FIG. 7 is a diagram of the trade contract data store according to the present invention, which is stored on the logistic data server of FIG. 4;

FIG. 8 is a diagram of the transport contract data store according to the present invention, which is stored on the logistic data server of FIG. 4;

FIGS. 9A-9I are a process flow diagram showing the steps used to identify, approve and select Shipper-Consignee pairs in accordance with the present invention;

FIGS. 10A-10I are a process flow diagram showing the logistical and financial management steps used for implementing an embodiment of the present invention; and

FIGS. 11A-11I are a process flow diagram showing the risk mitigation steps used for implementing an embodiment of the present invention.

### DETAIL DESCRIPTION OF THE PREFERRED EMBODIMENT

Reference will now be made in detail to the preferred embodiments of the present invention, examples of which are illustrated in the accompanying drawings. It is to be understood that the figures (FIGs.) and descriptions of the present invention included herein illustrate and describe elements that are of particular relevance to the present invention, while eliminating, for purposes of clarity, other elements. Those of ordinary skill in the art will recognize that other elements are desirable and/or required in order to implement the present invention. However, because such elements are well known in the art, and because they do not facilitate a better understanding of the present invention, a discussion of such elements is not provided herein.

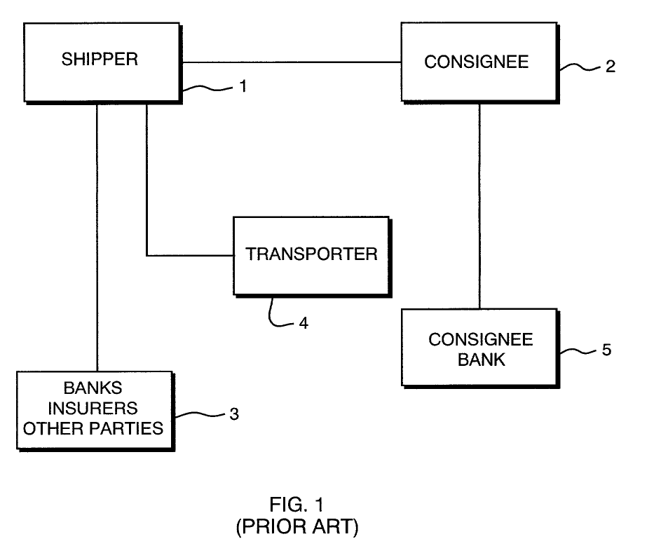

FIG. 1 illustrates parties which are involved in a conventional trade transaction involving transport of goods from a Shipper 1 to a Consignee 2. The Shipper 1, deals with banks, insurers, and other parties 3 to arrange finance for the production of the goods, for the transport cost, and any associated insurance. Once finance has been arranged, a Transporter 4 creates a transport contact, which if the transport is by sea, generally includes a bill of lading.

The transport contract describes the Shipper 1, the Consignee 2, the goods, the value of the goods, and details of the proposed journey. If the transport contract is a bill of lading, then the transport contract also serves to provide good legal title to the goods to the holder of the bill of lading. Meanwhile, the Consignee 2, requests funds from a bank 5 local to the Consignee to pay for the goods. Once the goods have been transported, either the Shipper 1 or the Consignee 2 arranges for payment to be made for the freight charges, thus allowing release of the goods covered by the bill of lading (if used) from the Transporter to the Consignee. Then the Consignee 2 settles the debt with the Shipper 1.

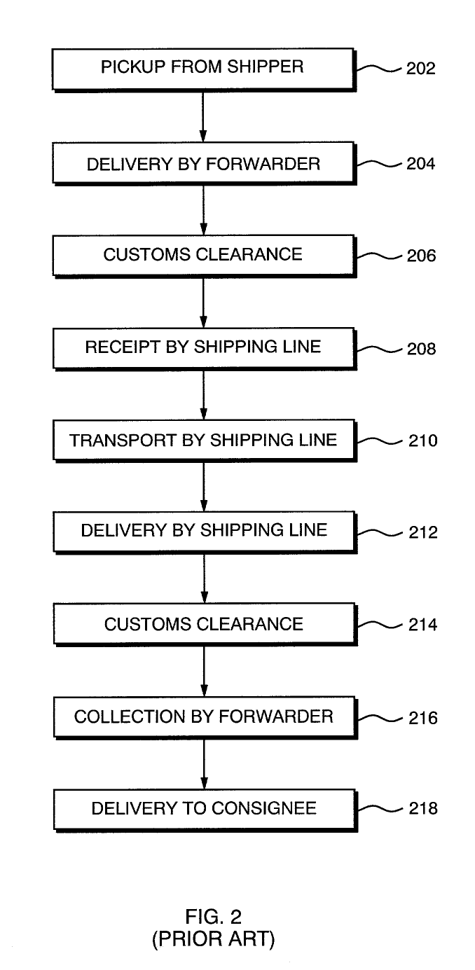

The transport of the goods involves a number of parties as illustrated in the flow chart of FIG. 2. In this example, goods are picked up from a Shipper by a trucker (step 202), then a forwarding company delivers the goods from the truck depot to the docks (step 204). After customs clearance (step 206), the cargo handlers are responsible for delivery of the goods to the shipping line for transport (step 208). Once the goods arrive at the destination port (step 212), cargo handlers are involved once more, and the goods are cleared through customs (step 214). The goods are then collected by a forwarder (step 216) and delivered to a truck depot, and finally a trucker delivers the goods to the Consignee (step 218).

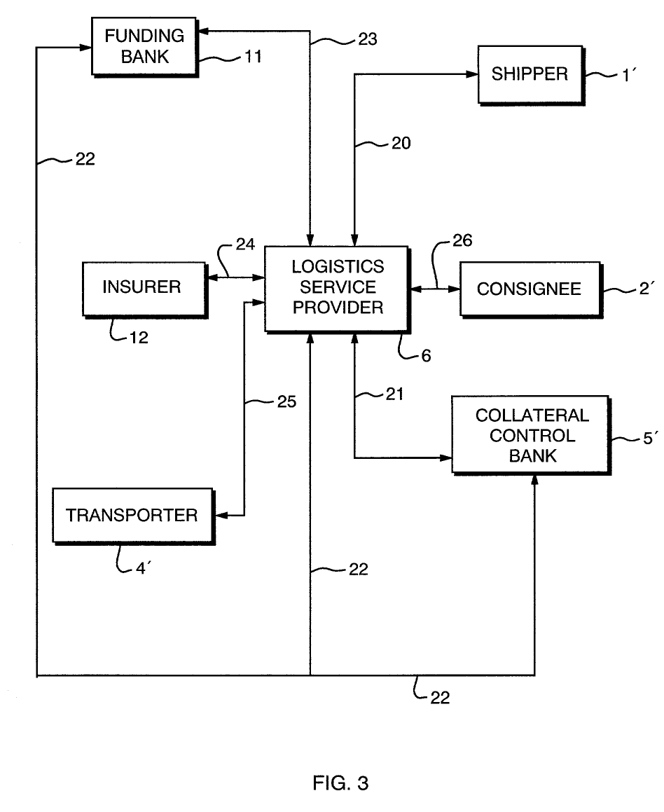

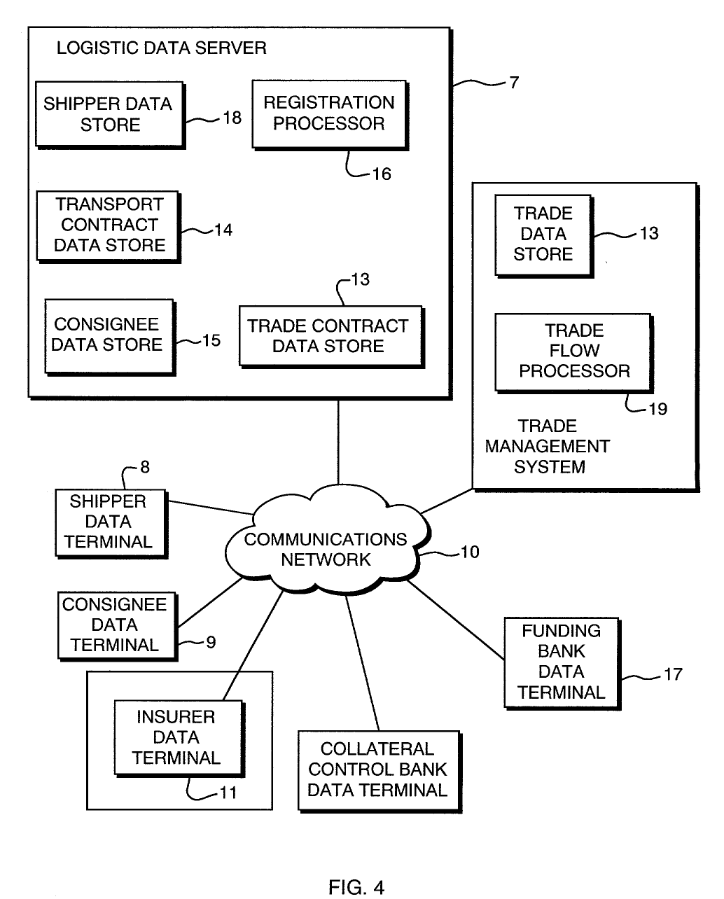

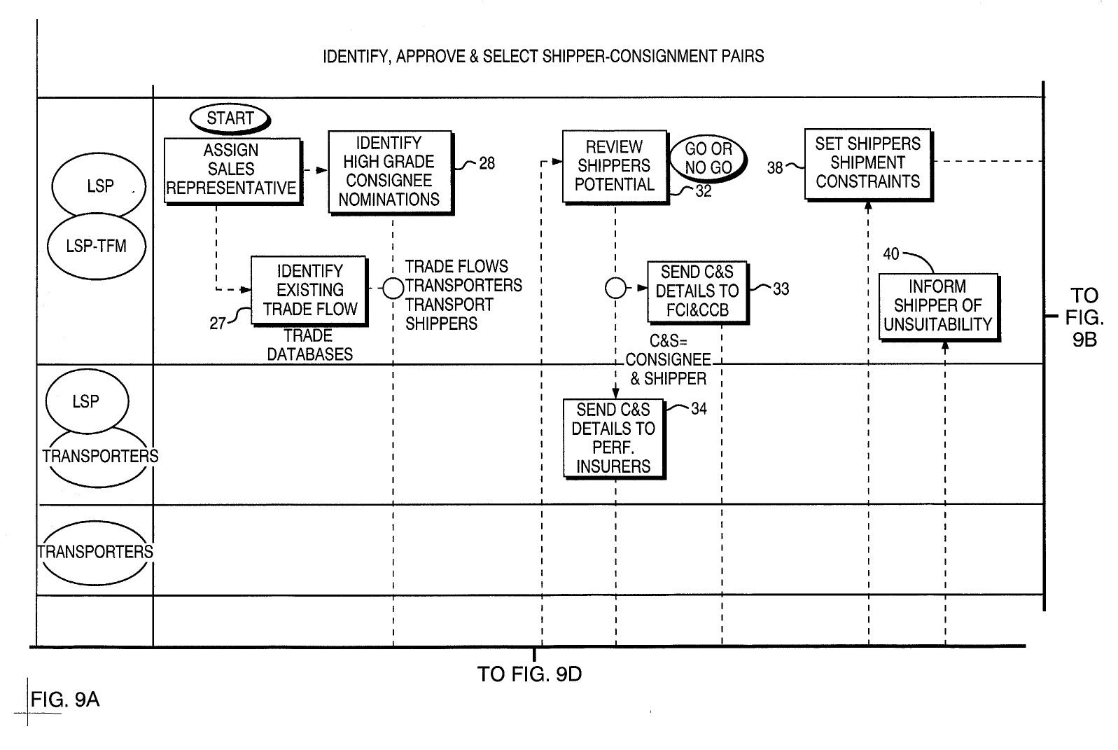

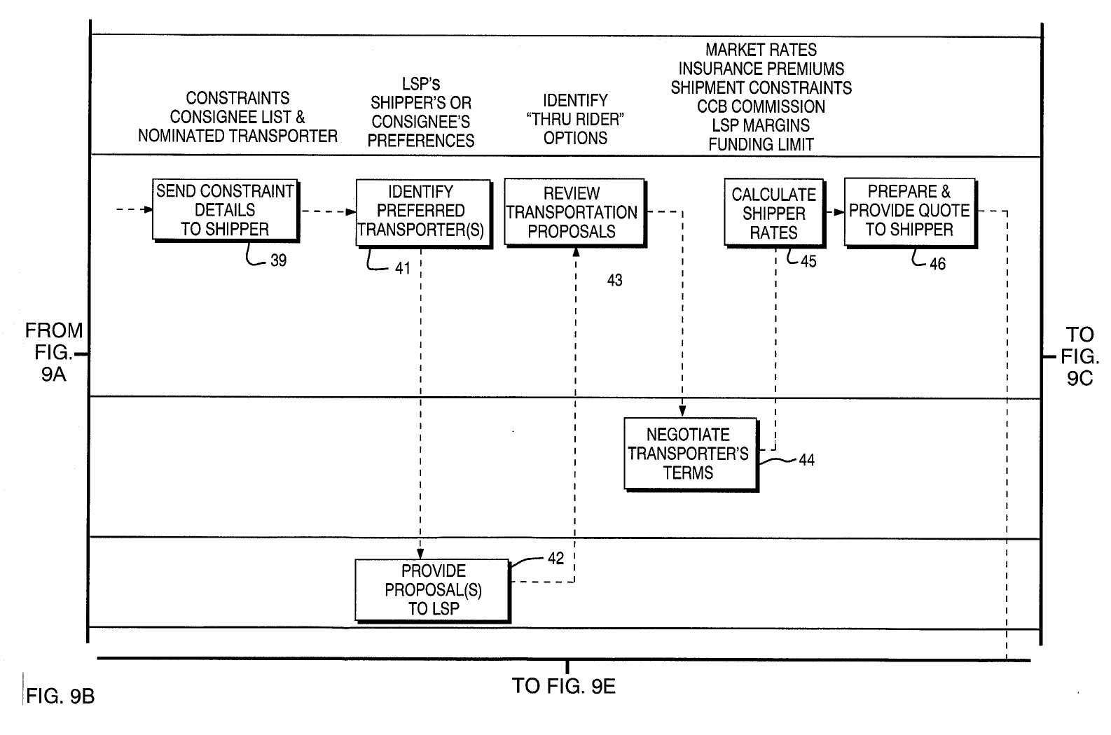

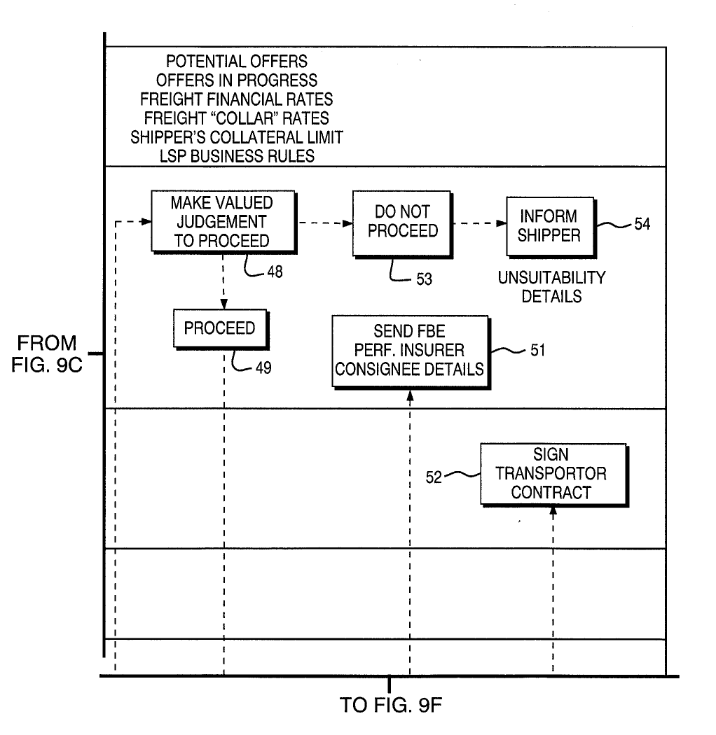

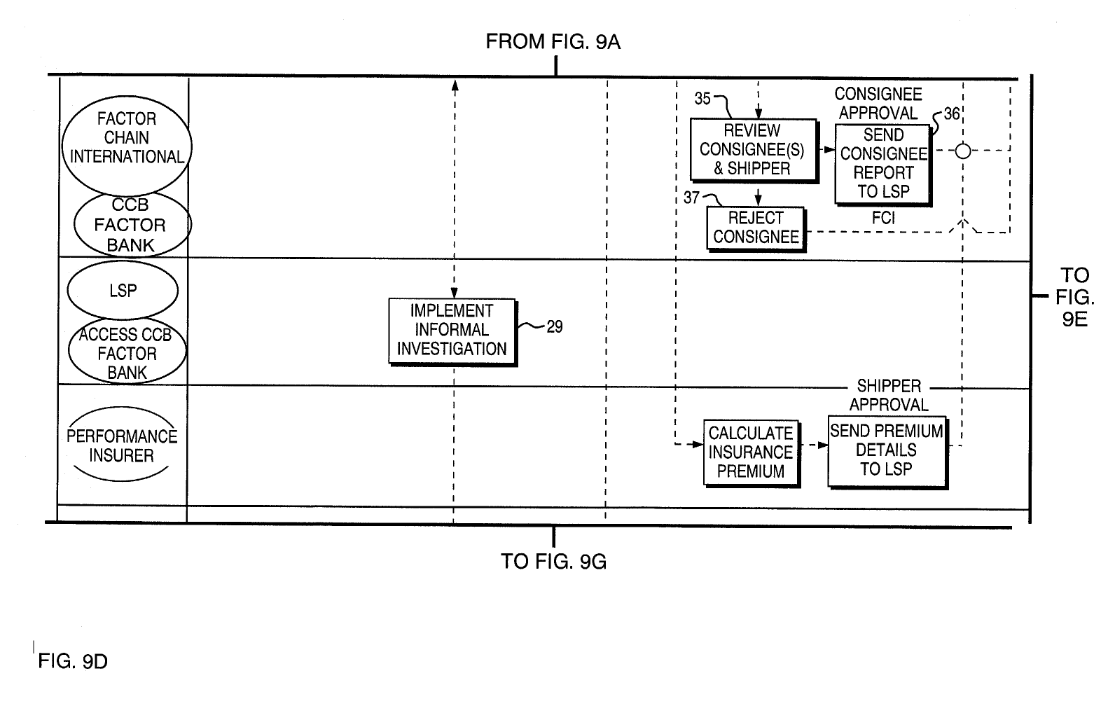

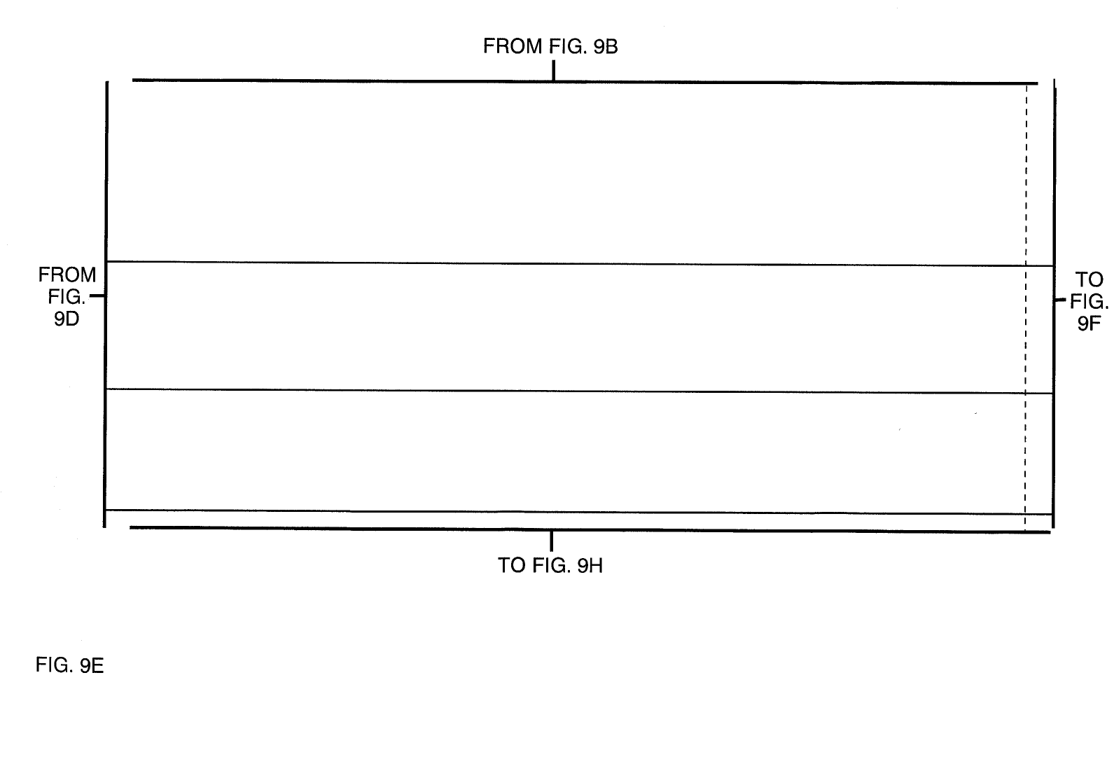

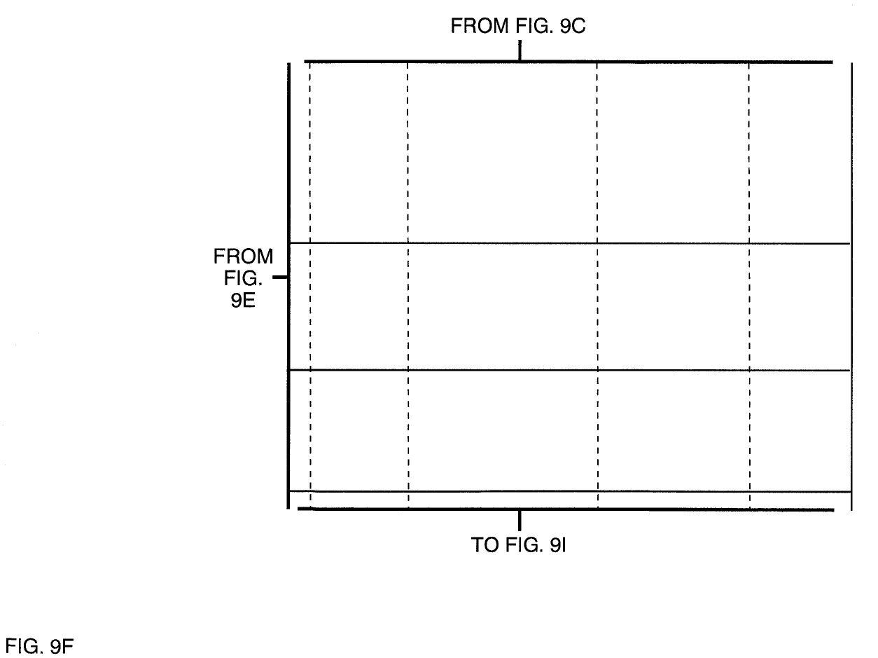

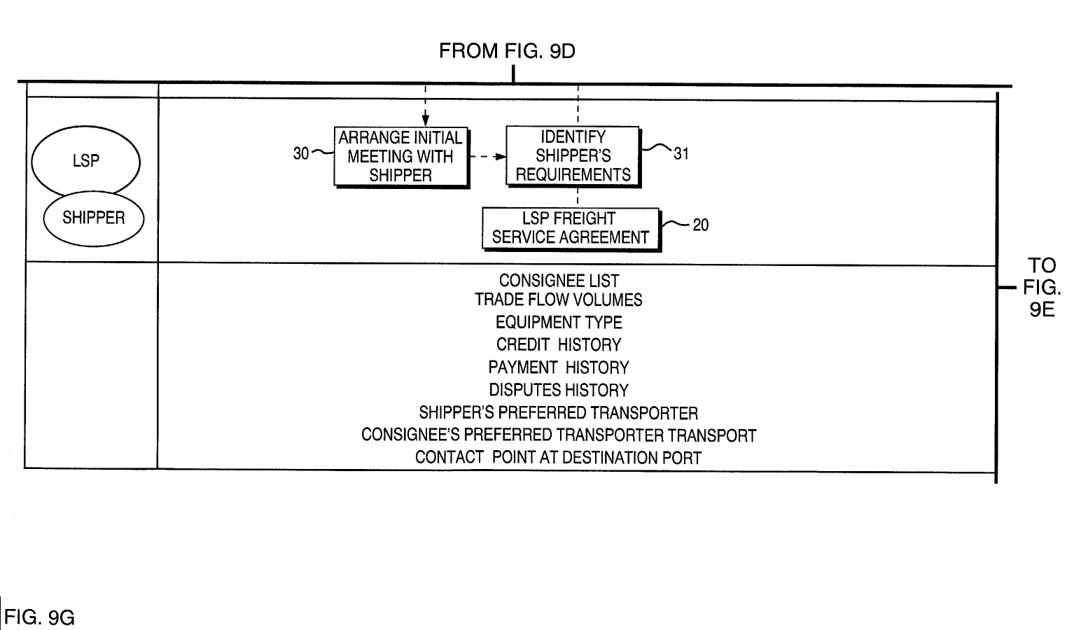

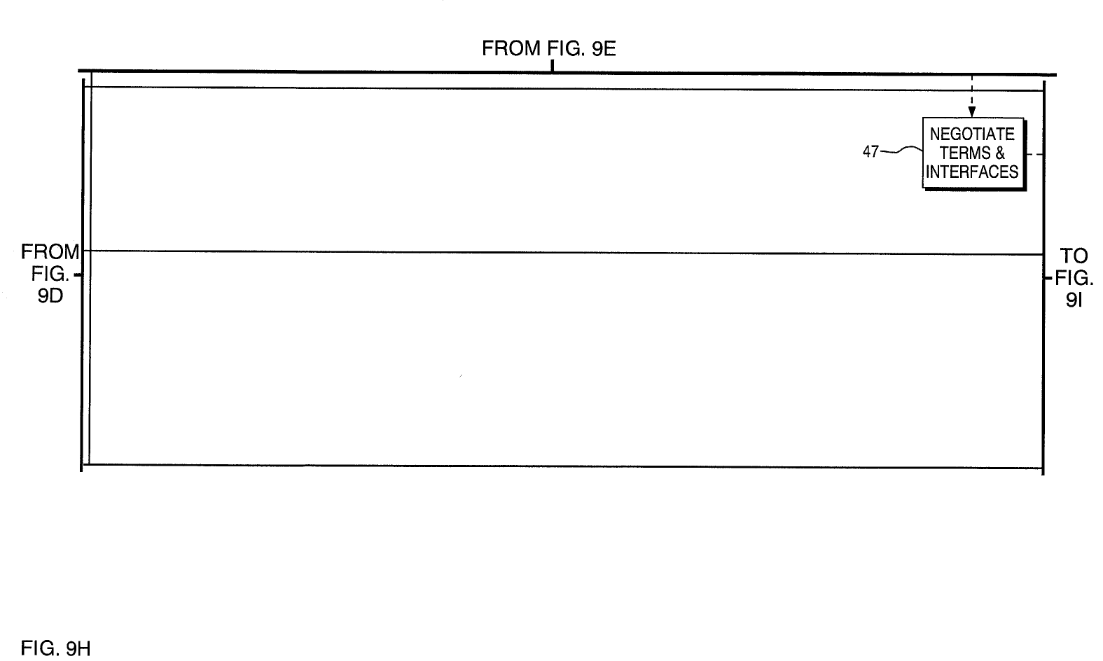

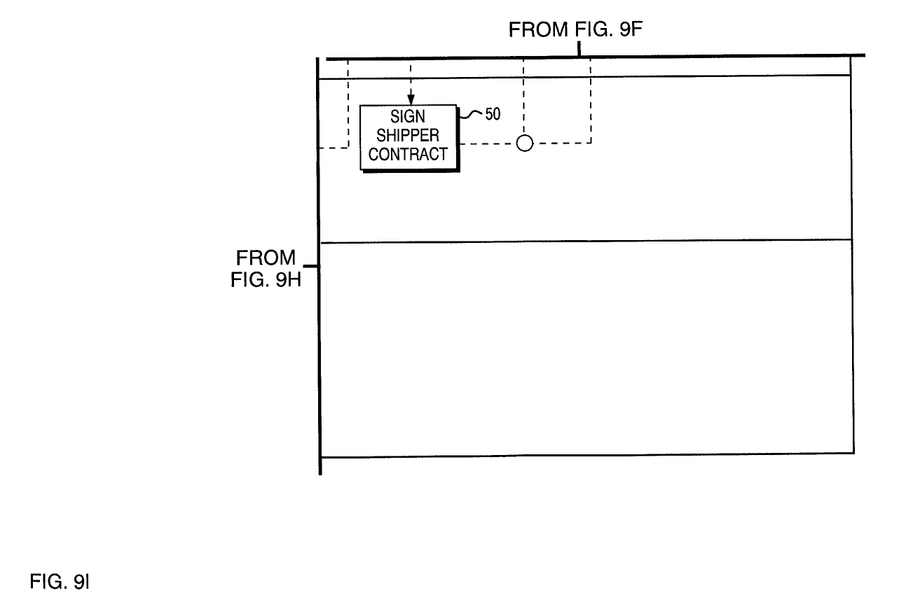

FIG. 3 illustrates schematically a method of facilitating funding of a trade transaction according to the present invention in which a LSP 6 is used. FIG. 4 illustrates an architecture for a data processing system which may be used to used to implement the method of the present invention. Referring now to FIG. 3 together with FIG. 4, a trade agreement for trade in goods is made between a Consignee 2′ and a Shipper 1′. The trade agreement may be made by conventional means such as correspondence by mail, electronic mail, meetings or telephone conversations. The Shipper 1′ and the Consignee 2′ will have previously registered with the LSP 6 as will be described later with reference to FIG. 9.

After the trade agreement has been made, a request for implementation of the trade agreement is sent to the LSP 6. The trade agreement may be sent to LSP 6 either by the Shipper 1′ or the Consignee 2′ and may be sent by conventional means such as by mail, facsimile, email, for example, or trade contract data relating to the agreement may be entered at a Shipper data terminal 8, or a Consignee data terminal 9, and the trade contract data then transmitted to a logistics data server 7, via a communications network 10, for storage in a trade contract data store 13.

Next, the trade agreement must be approved by LSP 6. Prior to approval, LSP 6 selects a number of business actors to support the trade transaction including a Funding Bank 11, a Performance Insurer 12, a Transporter 4′ and a Collateral Control Bank 5.

The Funding Bank 11 provides finance to the Shipper 1′ for the production of the goods, the transport costs, and any associated insurance. The Transporter 4′ is responsible for transporting the goods from the Shipper 1′ to the Consignee 2′, and includes for example, shipping lines, vessels for feeding goods from small ports to larger ports, barges, rail transport, trucks, and port functions such as cargo handling and customs. The Collateral Control Bank 5, which is generally local to the Consignee 2′, is responsible for ascertaining the credit rating of the Consignee 2′, collecting payment from the Consignee 2′, and transferring payment to the Funding Bank 11 upon delivery of the goods to the Consignee 2′.

The Performance Insurer 12 provides insurance for the transport of goods. This include performance insurance of the Shipper 1′, covering payment for the goods in the case of a dispute. The Funding Bank 11 is the beneficiary of the performance insurance.

Once the business actors have been selected, the trade agreement is approved by LSP 6 after it obtains various commitments from those business actors on the basis of, e.g., data relating to the Shipper 1′ and the Consignee 2′ stored at the logistics data server and on the basis of the ability of the actors making the commitments to have access to information on the overall logistics chain so that an accurate assessment of risk may be ascertained. Significantly, in the present invention, Transporter 4′ surrenders any security interest in the goods during transport, and allows the security interest to be used elsewhere rather than in grossly over securing the transport costs. In the present invention, at least part of the transport costs are paid prior to transport of the goods by LSP 6. During the approval process performed by LSP 6, the trade contract is transmitted from the logistics data server to the selected Transporter 4′ via the communications network 10. The Transporter 4′ produces a transport contract which may be in the form of a traditional bill of lading, or an electronic transport contract. If an electronic transport contract is used, then this is transmitted back to the logistics data server 7 for storage in the transport contract data store 14. If an electronic version of the transport contract is used, it can be stored in server 7 together with data which names the party currently having good legal title to the goods.

As part of the approval process, a request is also sent by LSP 6 to the Collateral Control Bank 5 via the communication network 10 to obtain a commitment from the Collateral Control Bank 5 . The Collateral Control Bank 5 checks the credit rating of the Consignee 2′, and has access to a Consignee data store 15 on the logistics data server 7, which provides information about other goods which may be in transit to the Consignee 2′, and may include an agreed credit limit for the Consignee 2′ in relation to trade with the Shipper 1′. Together with the transport contract data stored in the transport contract data store 14, this credit information allows the Collateral Control Bank 5 to make a decision as to whether a commitment can be made. If the Collateral Control Bank 5 issues a commitment, the Collateral Control Bank 5 will agree to, among other things, collect payments due from the Consignee 2′ on agreed credit terms, and to provide credit protection to the Funding Bank 11 to cover risks associated with non-payment by the Consignee 2′ of amounts due under trade contract upon receipt of the goods by the Consignee 2′. Such an arrangement is of major benefit to the Shipper 1′, because a local bank with local knowledge and language skills handles the collection activity. Significant value arises from increasing the likelihood that invoices are paid on time.

As part of the approval process, a request is also sent to the Performance Insurer 12 via the communications network 10 to obtain a commitment that the Performance Insurer 12 will provide performance insurance, in the event of a dispute under the trade agreement. In order for the Performance Insurer 12 to be able to make this commitment, the Performance Insurer needs to have a good overall view of the risks involved. The Performance Insurer will have access to data stored at the logistics data server 7. In particular, the Performance Insurer will have access to data relating to the Shipper 1′ in the Shipper data store 18, and data relating to the Consignee 2′ in the Consignee data store 14. The data relating to the Shipper 1′ and the Consignee 2′ may include data relating to previous trade agreements made by the particular parties involved.

Once the relevant commitments have been received from the Collateral Control Bank 5, the Transporter 4′, and the Performance Insurer 12, LSP 6 sends a request via the communications network 10 to the Funding Bank 11 to obtain a commitment to provide funds for any payments due under the trade contract, without recourse to the Shipper 1′, based on these respective commitments.

Many of the usual risks in a trade transaction stem from the fragmented nature of the conventional financing of trade process. In the method of the present invention, risks are reduced due to the commitments, based on predetermined risks, obtained before the transport takes place. Furthermore, the risks are consolidated, allowing a better assessment of the overall risk.

Once the LSP 6 has secured all the required commitments, the transfer of goods may commence. At this point, the Transporter 4′ surrenders its security interest in the goods and the security interest, or at least constructive control of the security interest, is transferred to the Funding Bank 11 or to the LSP 6 on behalf of the Funding Bank 11 and/or the Collateral Control Bank 5. This may be effected by physical transfer of a paper bill of lading and the invoice in respect of the trade contract, or by some other means, for example by recording the Funding Bank 11 as having good legal title to the goods in an electronic version of the transport contract stored in the transport contract data store on the logistics data server 7.

Once the Funding Bank 11 is satisfied that it has a security interest in the goods, it releases funds for finding the transport and insurance of the goods, and for a payment to the Shipper 1′. Initially, these funds are released to the LSP 6, which arranges payments to the Transporter 4′, to the Shipper 1′ and to the Performance Insurer 12. These payments include a payment to the Transporter 4′ covering all or part of the costs of shipment, a payment to the Shipper 1′ covering all or part of the amounts due to Shipper 1′ under the trade agreement, and a payment to insurer 12 covering the costs of the performance insurance. Significantly, the Funding Bank 11 releases amounts for these payments without recourse to the Shipper 1′ based on the performance insurance provided by the Performance Insurer 12 and the payment commitment issued by the Collateral Control Bank 5.

The goods are transported to the Consignee 2′ according to the terms of the transport contract. Upon receipt of the goods by the Consignee 2′, the Collateral Control Bank 5 attempts to collect payment from the Consignee 2′, according to agreed credit terms. If there is no failure of performance by the Shipper 1′, but the Consignee 2′ fails to make payment to the Collateral Control Bank 5 upon receipt of the goods, the Funding Bank 11 is protected, as the Collateral Control Bank 5 has committed to provide credit protection to the Funding Bank 11 to cover risk associated with non-payment by the Consignee 2′ of amounts due under the trade contract upon receipt of the goods by the Consignee 2′.

The Funding Bank 11 then releases any remaining funds to the LSP 6, which in turn makes any remaining payment to the Shipper 1′.

If the Shipper 1′ has failed to perform (e.g., the goods received by the Consignee 2′ failed to meet the specifications, requirements or standards set forth in the trade agreement) and is unable to refund the monies due, the Performance Insurer 12, rather than the Collateral Control Bank 5, transfers funds to the Funding Bank 11 in accordance with the insurance contract provided by insurer 12.

For the Shipper 1′, the LSP 6 provides a single point of contact for organization of transport, trade finance and insurance. A Shipper 1′ registers with LSP 6 in order to use the logistics services provided. The Shipper 1′ effectively requests registration of a trade channel for each Consignee 2′ with which the Shipper 1′ wants to do business, using an application form from the LSP 6. The application form is transmitted via the communications network 10 to the Shipper data terminal 8. The application form requires certain data from the Shipper 1′, for example: the name of the Shipper, the Shipper's usual Funding Bank; the nature of goods supplied by the Shipper; financial data, such as existing credit limits; expected volume of shipments per year; usual distribution channels; whether the business is seasonal, cyclical or steady; geographical distribution of the Shipper's business; names and geographical location of consignees with which the Shipper wishes to register a trade channel; and the credit relationship of the Shipper with each consignee (e.g. existing credit limits, time limits applied). Once this data has been entered on the electronic application form it is transmitted to a registration processor 16 of the logistics data server 7. The registration processor then stores the data in the Shipper data store 18.

The Collateral Control Bank 5 determines whether credit can be given for each Consignee 2′ with which the Shipper 1′ wishes to do business. If credit cannot be given, then a trade channel with that particular Consignee 2′ cannot be registered with the LSP 6. If credit can be given, a credit limit is determined by the Collateral Control Bank 5. The relevant credit data in relation to trade with that particular Shipper 1′ is stored in the Consignee data store 15. Finally, a copy of the credit data may be transmitted via the communications network 10 to the Shipper 1′ so as to inform the Shipper 1′ of the credit terms available.

The arrangement of a logistics chain as described above, requires the formation of a large number of separate contracts. For example, there are contracts between the Shipper 1′ and Consignee 2′, the Shipper 1′ and LSP 6, and between the Transporter 4′ and the Shipper 1′. The LSP 6 provides a logistics data server 7 to assist in the process of completing these contracts. The transport contract is stored on the logistics data server 7 in the transport contract data store 14, and may be accessed by the Performance Insurer 12, the Funding Bank 11, and by the Transporter 4′ in order to assist in this process. The Shipper 1′ and the Consignee 2′ may also have access to the transport contract data store 14.

The Funding Bank 11 can recover the funding it has provided from the Consignee 2′ via the Collateral Control Bank 5. In this way, the value of the goods being transported is used to securitize the lending of the money by the Funding Bank 11, is Furthermore, by storing transport data as a central record, transport data handling can be carried out centrally and efficiently.

Such a system has the advantage that instead of maintaining a set of contracts which are not necessarily connected together, the transport data are collected in a single data store. This single data store can be inspected by a number of parties. There is only one data record relating to the transport contract, which helps to reduce errors in the handling of data relating to the transport of goods.

It is an advantage if the method of the present invention is performed centrally by a LSP 6 which has links to each of the Funding Bank 11, the Performance Insurer 12, the Consignee 2′, the Collateral Control Bank 5, the Shipper 1′ and the Transporter 4′. That is, any party able to inspect the data record shall know that the entity identified by system 7 as having the legal title to, or a security interest or lien on, the goods in fact has enforceable legal title to the goods during transport. For example, the entity identified by the legal title identification data in system 7 may have a security interest or lien on the goods whereby the goods may not be disposed of without permission of the entity identified or the right to collect payment for the goods. Suitably, the legal title identification comprises a statement to the effect that the invoice and the right to collect payment of the invoice have been assigned from the Shipper 1′ to the Collateral Control Bank 5.

Any suitable means may be used to ensure that the legal title identification data gives the entity identified enforceable legal title. Suitably, this is obtained by way of a contract or other legally enforceable registration agreement between the operator of the transport data processing system 7 (e.g., LSP 6) and Shipper 1′, the Transporter 4′, LSP 6, the Collateral Control Bank 5, and the Funding Bank 11. Such a registration agreement can be secured for example, when each of these parties registers with system 7.

The logistics data server 7 may also be connected, via the communications network to a trade management system 19 which is adapted to provide information to users concerning the location of goods. The trade management system consists of a trade data store 13 and trade flow processor connected to a logistic data server 7 via a communications network 10, to which other logistics, finance, and trade compliance systems may also be connected. This is commonly referred to as a “track and trace” system. In this case, the transport contract data store is updated regularly to provide information relating to the current status and location of the goods. Updates are provided by both the Transporter 4′ and LSP 6. Such a track and trace system may be implemented by use of radio frequency (RF) identity tags which comprise a data store containing information similar to that contained by a conventional optically read bar code, but which may be read remotely by via radio links. Advantages over bar code technology include the fact that line of sight is not required for reading encoded data, and that many tags may be read simultaneously. This makes the technology ideal for monitoring progress of goods in transit. Each palate in a container may have such an RF identification tag, thus providing a secure method of obtaining the status of goods in transit. This data may be transmitted to the LSP 6, and stored on the logistics data server 7, so that up to date information relating to the status of the goods is obtainable by interested parties.

A successful trade transaction between Shipper 1′ and Consignee 2′ requires the performance of a sequence of trade flow steps that ultimately results in the exchange of physical goods for financial value. Each step has an expected duration and an expected success rate or probability of success so that, for the trade transaction as a whole, it is possible to calculate the expected delivery date (e.g., completion of the physical move) and completion date (e.g., completion of the whole transaction including financial payment), and the expected value realized from the trade. The objective of managing the trade flow is to maximize the expected value of the trade. The distinction between the expected value of the trade and the simple invoice value is that the expected value takes account of the likelihood of success and timeliness of the receipt of the payment.

When the trade management system 19 detects a relevant event, the trade management system 19 determines whether the performance of the trade flow is still on target to proceed as planned or whether a corrective action should be considered. If the trade flow is still on target then a notification is passed to both the Transporter 4′ and LSP 6 of the current status and no further action is taken allowing the current actions to continue to completion.

If the trade flow is no longer on target to complete as per the plan, then the trade management system 19 queries the logistical, financial and trade compliance systems of the logistics data server 7 to determine available actions and initiates the action that maximizes the expected value. Notification is then passed to the Transporter 4′ and LSP 6 of the updated trade flow plan and expected completion date.

The transport contract data store 14 contains the following data: Shipper 1′ identification data 801; goods identification data 804; pick up data (identifying the physical location and time for pick up of the goods) 803; Consignee 2′ identification data 802; delivery data (identifying the physical location and time for delivery of the goods); invoice value data 806; payment terms; and the trade flow plan. The trade flow plan specifies the logistic and trade steps necessary to perform the trade successfully and their expected completion dates.

The trade management system 19 monitors the status of the trade flow via the communications network to detect the occurrence of relevant logistics, finance or trade compliance events indicating the successful completion of an action, the occurrence of a problem, or a change in the trade or financial constraints appropriate to the trade flow.

When a relevant event is detected the trade management system 19 checks to see whether the performance of the trade flow is still on target to proceed according to the plan or whether a corrective action needs to be initiated. If the trade flow is still on target then a notification is passed to both the Transporter 4′ and LSP 6 of the change in status and no further action is taken allowing the current actions to continue to completion.

If the trade flow is no longer on target to complete as per the plan, then the trade management system 19 queries logistics, finance and trade compliance systems to determine available actions and initiates the action that maximizes the expected value to one or more of the parties to the trade transaction. The determination as to whether an alteration of the planned movement of the goods should be made, is based, at least in part, on the financial costs involved, the credit risks involved and the potential to avoid disputes. Assessment of the financial costs involved focuses on the increased or additional costs which will be incurred as a result of altering the planned movement of the goods. The financial costs may be borne by at least one of the Shipper, Consignee, Performance Insurer, Logistics Service Provider or Funding Bank. Assessment of the credit risks involved focuses on how the Consignee's 2′ credit limit and credit period may be affected by an alteration of the planned movement. The increased credit risk resulting from a delay in the shipment of the goods, may be borne by the Collateral Control Bank.

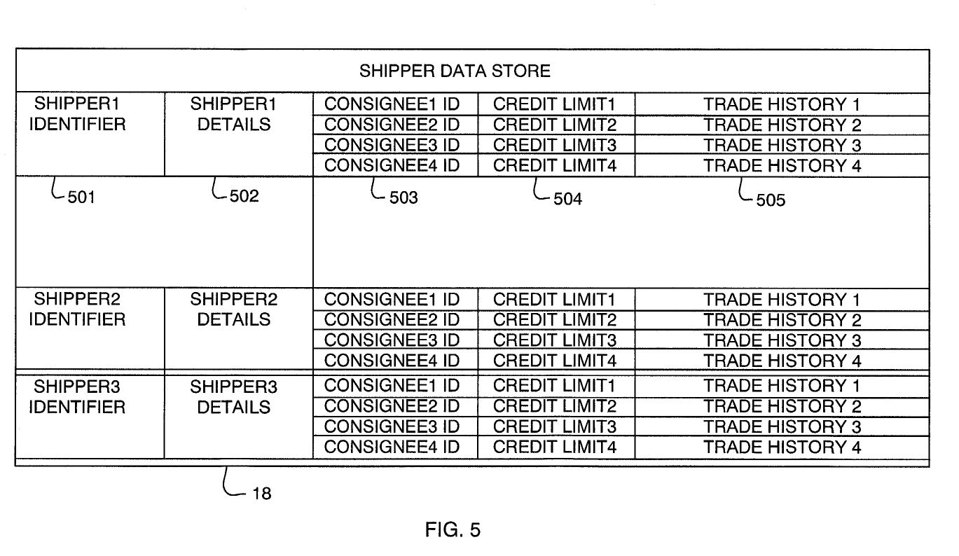

In one embodiment, the system determines whether an alteration in the planned movement of the goods should be made based, at least in part, on a financial cost that will be borne by the Shipper 1′, Consignee 2′, Performance Insurer 4′, Logistics Service Provider 6, Collateral Control Bank 5 and/or Funding Bank 11 as a result of the delay if the planned movement of the goods is not altered. Among other things, the system checks the various stored credit limit and credit period information for the various parties (see FIGS. 5-8), and determines whether, absent corrective action, a delay in the planned movement of the goods will cause a party to exceed its credit limit or credit period.

The transport data store 14 may be central linked to the physical goods through an identifier or stored in a storage device accompanying the goods (e.g., a RF tag or other electronic data store).

The trade management system 19 may be centrally located, or positioned locally at the locations through which the goods are passed. The trade management system 19 may also be mobile, being part of an electronic device accompanying the goods.

One example of how a transport system according to the prior art might function to take corrective action is as follows: a small, part load, shipment is delayed arriving at a port and misses planned sailing. As it is a part load, the transport manager decides to hold the shipment until the next regular (full) shipment the following month in order to consolidate the part load shipment into a full load and save transportation costs. However, despite the small size of the shipment, the shipment is associated with a high value invoice. The delay in delivery to the end customer results in an invoice for the shipment being paid a month later than planned, leading to large additional interest charges being incurred.

Utilizing the trade management system 19 of the present invention, when such a delay is about to occur, an alert is raised by the trade management system 19 linking the potential delay to payment of the corresponding invoice. The logistic data server 7 would determine the maximum amount that it is sensible to pay to bring the shipment back on track given the expected financial consequences and whether there is an available transport option to achieve this outcome. Either a corrective action is initiated automatically by the trade management system 19 or the relevant information is provided to LSP 6 trade flow manager to escalate or resolve the situation if the expected financial consequences to the Shipper 1′ or Consignee 2′ justify such action.

In another example of a shipment, managed by a trade management system found in the prior art, 200 boxes containing products inbound to a United States consignee, list St Petersburg as the final destination for various United States inland locations shipping to Denver. A minor paperwork error results in the arrival of the boxes at an incorrect delivery ramp two miles from the correct one in Denver. Upon delivery, the boxes are inspected and found to be overweight for US trucking regulations. This means that the products need to be removed from the boxes and repacked before they can be reshipped the two remaining miles. This issue was initially flagged by the transporter, but the transporter declined to incur the significant additional costs for corrective action without certainty of being able to reclaim money from the consignee should it prove necessary. The delay in this decision ultimately results in the total costs being significantly higher once the issue is finally resolved.

Utilising the trade management system 19 of the present invention, when the LSP 6 is alerted to problem by the trade management system 19, the approval for spending additional amounts to correct the situation can be given rapidly, provided the collateral and reserves held on account of the Shipper 1′ and Consignee 2′ are sufficient (as determined by the trade management system 19). As a consequence, corrective action is taken more rapidly and total costs are minimized.

In the present invention, LSP 6 preferably enters into a services agreement (SA) 20 with the Shipper 1′. In this agreement, LSP 6 may agree to provide Shipper 1′ with any of a range of services including financial, insurance, and logistics management services. In the SA 20, the Shipper 1′ covenants to behave in a particular way during the various steps of the transport transaction. Among other things, Shipper 1′ covenants that all information and documents provided to LSP 6 are complete and accurate and that the goods being shipped will meet the specifications and expectations of Consignee 2′. The Shipper 1′ also covenants to take back any goods (or otherwise make good) in the event of any problems with the goods being shipped.

As a result of the covenants of Shipper 1′ in the SA 20, the Shipper 1′ is placed, vis a vis LSP 6, in virtually the same position as if LSP 6 had been a lender to Shipper 1′. The SA 20 gives LSP 6 broad remit to pass on or withhold the proceeds of a financing, and to alter terms of financing if directed to do so by other parties to the financing transaction.

The SA 20 also sets out the documentation the Shipper 1′ must produce for each shipment, the form by which the Shipper 1′ assigns its interest in the goods being transported to the LSP 6 (and on to the Collateral Control Bank 5), the procedures for supplying information to obtain credit approvals, and the obligations on the part of the Shipper 1′ in cases of dispute. For example, under the SA 20, the Shipper 1′ must provide a customer list, scheduling the trading history of each customer, including the credit line sought, high and low credits and dispute history. These will be cross checked by the Collateral Control Bank 5. Further, the Shipper 1′ must undergo an investigation to determine his compliance with the credit, performance, and dispute history standards of LSP 6.

The present invention also uses a factoring agreement (FA) 21 ordinarily used between a “foreign” factor (LSP 6) and a “domestic” factor (Collateral Control Bank 5) for the domestic to provide factoring services (assumption of credit risk and collection) on behalf of the “foreigner's” clients. For other agreements, and, in particular, the agreement with the Funding Bank 11, the FA 21, creates the borrowing capacity against which the Funding Bank 11 will lend. For example, the FA 21 may include specific clauses in respect of how disputes will be resolved, and by whom and, in particular, circumstances under which invoices can charged back from Collateral Control Bank 5 to LSP 6.

Under an assignment of proceeds agreement (APA) 22, the LSP 6 assigns its rights under the FA 21 to the Funding Bank 11. In this embodiment, the Shipper 1′ has no legal relationship with either the Collateral Control Bank 5 or the Funding Bank 11. This APA 22 is executed by the Collateral Control Bank 5, the LSP 6 and the Funding Bank 11.

The present invention also uses a Funding Bank agreement (FBA) 23. The FBA 23 specifies the LSP's 6 procedure for review and underwriting (credit review and analysis) of shippers. For example, the FBA 23 may require the LSP 6 to perform a financial due diligence exercise on each Shipper 1′ (or potential client), including review and analysis of financial statements and the Shipper's 1′ operation. The FBA 23 may also require that such underwriting files be made available to the Funding Bank 11 for review. The FBA 23 may also give the Funding Bank 11 authority to object (or reject) any relationship with a Shipper 1′ prior to inception of the relationship.

In some embodiments, the FBA 23 will also set forth the procedure for performance history review of each Shipper 1′ and the performance standards that will be required of each Shipper 1′.

The FBA 23 may also set forth the procedure for resolution of disputes. In one embodiment, LSP 6 plays a central role vis a vis the Collateral Control Bank 5 and the Performance Insurer 12 in connection with the handling of such disputes. For example, the FBA 23 may require the LSP 6 to manage all disputes on a “proactive” basis, and may, for example, be required to withhold or sequester cash belonging to particular Shippers 1′ where there is an ongoing dispute. It is also possible that, within a specified period of a dispute being notified, the LSP 6 may be required to have details of the dispute determined and have a binding “statement of facts” prepared.

The FBA 23 may also set forth the procedure for drawdowns, relating to the “availability” of collateral as signaled by the Collateral Control Bank 5. These drawdown procedures will preferably conform to the procedures by which LSP 6 assembles and submits documentation on shipments to the Collateral Control Bank 5. For example, when the LSP 6 sends the Collateral Control Bank 5 a file of documents supporting a shipment, the Collateral Control Bank 5 shall ledger the invoice and send an electronic message to the LSP 6 indicating that the invoice has been ledgered, and indicating the extent of credit exposure accepted by the Collateral Control Bank 5. This electronic message will be available simultaneously to the Funding Bank 11 and the Performance Insurer 12.

The FBA 23 may also set forth procedures for identifying problems (i.e., “escalations”) and reporting these as relevant (i.e., every escalation is not necessarily linked to a potential banking consequence). For example, the LSP 6 may be required under the FBA 23 to log all escalations and make these files available to the Funding Bank 11 on an as requested basis.

The FBA 23 may also set forth procedures for monitoring the financial status of Shippers 1′. For example, the LSP 6 may be obliged under the FBA 23 to update various files noted above, and to make regular reports to the Funding Bank 11 and the Performance Insurer 12.

The present invention also uses an insurer Agreement (IA) 24 which sets forth the circumstances under which the Performance Insurers 12 will pay out in cases of disputes, and will establish the requirements that LSP 6 will need to have satisfied (e.g., withheld funds, notice, etc) before cover becomes effective. The loss payable beneficiary under the IA 24 is the Funding Bank 11. As was the case with Funding Bank 11, the Performance Insurer 12 may require review of the underwriting file of the Shipper 1′, in order to make an independent judgement as to the insurability of any Shipper 1′ prior to entering into the IA 24. The system shown in FIG. 4 facilitates the electronic transfer of this information to the Performance Insurer 12. In many cases, without insurance, the Funding Bank 11 might be unwilling to allow the LSP 6 to begin a relationship with a particular Shipper 1′.

The present invention uses a transporter Agreement (TA) 25 which is similar to conventional TA's, with the following exceptions: the deletion and/or modification of clauses limiting liability: the deletion and/or modification of clauses dealing with dispute resolution procedures; the deletion and/or modification of clauses; specifying, the guaranteed provision of space on particular modes of transport at specified times; the deletion and/or modification of clauses (in forwarder docs) about retention of title to goods, being transported etc.; the addition of clauses for line to acknowledge LSP 6 role as agent for shopper; the addition of provisions for access to information provided by the Transporter 4′ to the Shipper 1′; the addition of clauses to produce certain documents within agreed time frames.

FIG. 5 is a diagram of a shipper data store in accordance with the present invention, which is stored on the logistic data server 7 of FIG. 4. As mentioned previously, the Shipper 1′ must register with the LSP 6 in order to use the logistics services provided. Data relating to the Shipper 1′ and to trade channels which the Shipper 1′ has registered with the LSP 6 is stored in a shipper data store 18. A shipper identifier is stored in field 501 together with details about the shipper in field 502. For each Consignee 2′ with whom the Shipper 1′ wishes to do business, a consignee identifier is stored in field 503 together with an approved credit limit in field 504. Details of any historical trade transactions between the shipper identified infield 501 and the Consignee 2′ identified in field 503 are stored in a trade history field 505.

The registration processor 16 then stores the data in the shipper data store 18. Consignees 2′ may also register with the logistics data server 7, using a similar mechanism. In this case an overall credit limit for the particular Consignee 2′ is set by the Collateral Control Bank 5′.

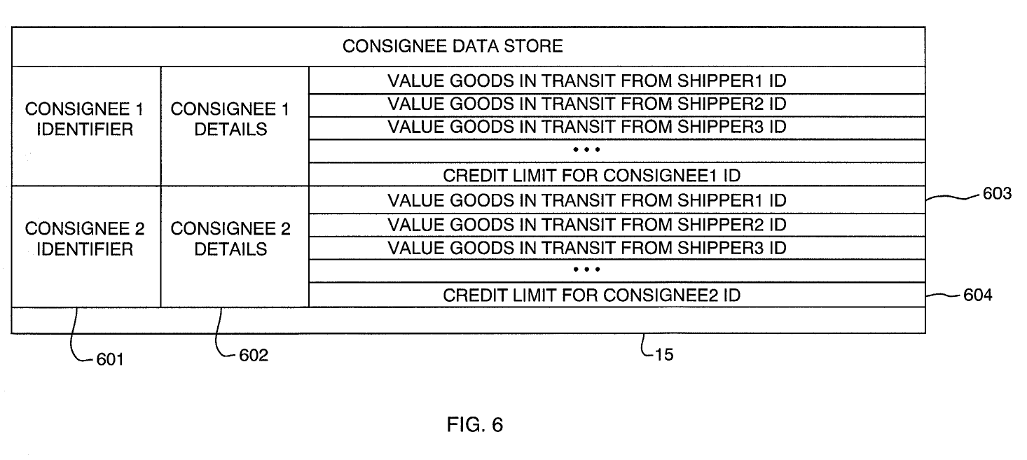

FIG. 6 is a diagram of a consignee data store according to the present invention, which is stored on the logistic data server 7 of FIG. 4. A consignee identifier field 601 is used to identify the Consignee 2′, and a details field 602 stores information about the Consignee 2′ identified in field 601. Field 603 stores data relating to goods in transit to the Consignee 2′ from particular Shippers 1′. Field 604 stores data relating to the maximum credit available to the Consignee 2′.

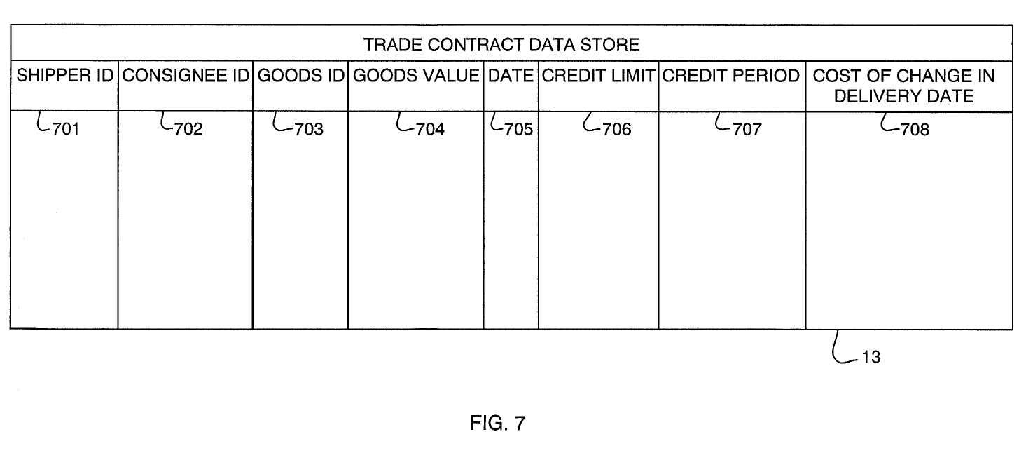

FIG. 7 is a diagram of a trade contract data store in accordance with the present invention, which is stored on the logistic data server 7 of FIG. 4. A shipper identifier. Field 701 stores data identifying the Shipper 1′. A consignee identifier field 702 stores data identifying the Consignee 2′. A goods identifier field 703, and a goods value field 704 store data identifying the goods to be transported and the value of the goods. A date field 705 stores data indicating the date by which the goods are required. Fields 706, 707 and 708 contain data relating to the credit terms approved between the Shipper 1′ indicated in the shipper ID field 701 and the Consignee 2′ indicated in the consignee ID field 702. The credit limit field 706 stores information relating to the amount of credit available to the Consignee 2′ identified in the consignee ID field 702. The credit period field 707 stores information relating to the length of time credit may be available to the Consignee 2′ identified in the consignee ID field 702. The cost of change in delivery date field 708, stores information about how the expected value of the trade transaction to various parties will change as the actual delivery date for the goods varies from the target delivery date (stored in field 705). For example, with respect to the Consignee 2′, field 708 might store the following information:

TABLE 1

| Difference Between Actual | Change in |
|---|---|
| Delivery Date and Target | Expected Value |
| Deliver Date (in days) | to Consignee |
| −3 | −$3,000 |
| −2 | −$2,000 |
| −1 | −$1,000 |
| 0 | 0 |
| (target Arrival Date) | |
| 1 | 0 |
| 2 | 0 |
| 3 | −$5,000 |
| 4 | −$10,000 |
| 5 | −$15,500 |
| 6 | −$250,000 |
| 7 | −$250,000 |
| 8 | −$250,000 |

The example of Table I reflects that the Consignee 2′ will incur storage charges of $1,000/day for each day that the shipment is early. Such a situation might occur where the Consignee 2′ was a manufacturer that was unable to begin using the goods until the target arrival date. The example also reflects that no change in expected value will accrue to the Consignee 2′ if the shipment is only 1 or 2 days later. If the Consignee 2′ ran an assembly line (which needed the goods being shipped in order to operate), but the Consignee 2′ could re-deploy its workers/resources to other tasks for 1 or 2 days, then this would result in no change in expected value to the Consignee 2′ if the shipment were 1 or 2 days late. After the shipment is delayed by three days or more, Table I reflects that the Consignee 2′ will begin losing $5,000/day for each day the shipment is delayed. This cost could reflect, for example, the fact that, after 2 days of delay, the Consignee 2′ may have to pay its assembly line workers $5,000/day to sit idle. Finally, Table I reflect that, if the shipment is delayed 6 days or more, the Consignee 2′ may, for example, default on a supply obligation to a customer and incur a liquidated damages penalty of $250,000.

In operation, the trade management system 19 monitors how many days the actual shipment delivery date varies from the target delivery date as the shipment progresses. When there is a variance, the trade management system 19 compares an additional cost of expending/delaying shipment (i.e., the cost of the corrective action) to, for example, the change in expected value to the Consignee 2′. Assuming, for purposes of the example of Table I, that the cost of corrective action by expediting a delayed shipment was $1000 for each day that the actual delivery was expedited, and the cost of corrective action by delaying an early shipment was $500 for each day that the actual delivery was delayed, then the trade management system 19 would indicate/not initiate corrective action by comparing the cost of corrective action to the change in expected value if the corrective action is not taken. In one embodiment, trade management system 19 chooses to initiate corrective action whenever to do so is cheaper than a change in expected value to the Consignee 2′ absent such corrective action. Thus, in the current example, trade management system 19 would initiate/not initiate correction action as follows:

TABLE II

| Difference Between Actual | |
|---|---|
| Delivery Date and Target | |
| Deliver Date (in days) | Correction Action |
| −3 | Delay shipment for 3 days |
| −2 | Delay shipment for 2 days |
| −1 | Delay shipment for 1 day |
| 0 | Take no corrective action |
| 1 | Take no corrective action |
| 2 | Take no corrective action |
| 3 | Expedite shipment 1 day |
| 4 | Expedite shipment 2 days |
| 5 | Expedite shipment 3 days |
| 6 | Expedite shipment 4 days |

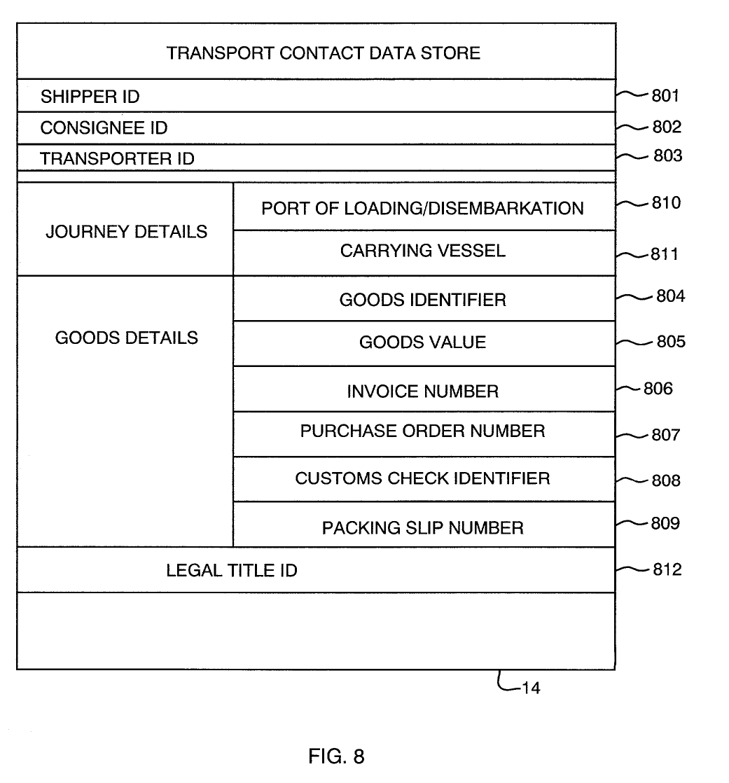

FIG. 8 is a diagram of a transport contract data store in accordance with the present invention, which is stored on the logistic data server 7 of FIG. 4. The transport contract data store 14 has a shipper identifier field 801, a consignee identifier field 802 and a transporter identifier field 803 for storing data identifying the Shipper 1′, the Consignee 2′ and the Transporter 4′ respectively. A number of fields relate to the goods, namely a goods identifier field 804, a goods value field 805, an invoice number field 806, a purchase order number field 807, a customs check identifier field 808 and a packing slip number field 809. Data relating to the details of the transport of the goods are stored in field 810, including data relating to the ports of loading and disembarkation. Field 811 stores data relating to the carrying vessel. Field 812 stores data relating to the party currently with good legal title to the goods during transport.

The transport contract data may be accessed by the Performance Insurer 12, the Funding Bank 11, and by the Transporter 4′. The Shipper l′ and the Consignee 2′ may also have access to the transport contract data store 14.

Rather than depending on the delivery of a paper copy of the bill of lading to the Shipper 1′ and the Transporter 4′, the transport data is stored in the transport contract data store 14 and is adapted to give good legal title to the goods during transport. Because the Funding Bank 11 has access to the transport contract data store 14, the Funding Bank 11 can check that it has legal title to the goods by inspecting data in the transport contract data store 14. If the Funding Bank 11 has good legal title to the goods during transport, the Funding Bank 11 can release funds. These funds are used to pay a part of the Shipper's 1′ charges for the goods or to pay the Transporter 4′ for the transport costs. Part of the funding is also used to pay for insurance to cover the aforementioned risks involved in the transport of goods.

The Funding Bank 11 can recover the funding it has provided from the Consignee 2′ via the Collateral Control Bank 5′ which may collect such funds. The Funding Bank's 11 legal title to the goods provides it with some security in recovering the money lent. In this way, the value of the goods being transported can be used to collateralize the lending of the money by the Funding Bank 11. Furthermore, by storing transport data as a central record, transport data handling can be carried out centrally and efficiently.

FIGS. 9A-9I are a process flow diagram showing the steps used to identify, approve and select Shipper 1′-Consignee 2′ pairs in accordance with the present invention. In steps 27 and 28, the LSP 6 identifies existing trade flows and the Consignee(s) 2′ of the goods within such trade flows. Other entities identified within the trade flows include Transporters 4′ and Shippers 1′. In step 29, the LSP 6 identifies the Collateral Control Bank 5 and implements an informal investigation into the adequacy of the collateral. In steps 30 and 31, the LSP 6 then meets with the Shipper 1′ and identifies the Shipper's 1′ requirements. In step 20, A Service Agreement (SA) may then be put in place between the LSP 6 and the Shipper 1′ addressing such issues as trade flow volumes, equipment type, credit history, payment history, disputes, the Shipper's 1′ preferred Transporter 4′, Consignees 2′ preferred Transporter 4′ and the contact point at the destination port. In step 32, a further analysis is undertaken to determine whether the process should move forward with the identified Shipper 1′.

In step 33, the LSP 6 then sends the details relating to the identified Consignee 2′ and the identified Shipper 1′ to the Funding Bank 11 and Collateral Control Bank 5. In step 34, the LSP 6 also sends Shipper 1′ details to the Performance Insurer 12. In step 35, the Collateral Control Bank 5 reviews the information related to the Consignee 2′ and Shipper 1′ and either approves or rejects the Consignee 2′ in steps 36 and 37. Upon the Collateral Control Banks' 5′ approval in step 36, the LSP 6 sets the Shippers 1′ shipment constraints and sends the constraint details to the Shipper 1′ in steps 38 and 39. If, however, the Collateral Control Bank 5 rejects the Consignee 2′ in step 37, the Collateral Control Bank 5 then informs the LSP 6 of the unsuitability of the Shipper 1′ in step 40.

Once the Shipper 1′ has received the details of the shipment constraints, the LSP 6 identifies the preferred Transporter(s) 4′. In step 41, the Transporter(s) 4′ then provide a proposal to the LSP 6 and the LSP 6 reviews the Transporter's 4′ proposal in steps 42 and 43. The LSP 6 and the Transporter 4′ then negotiate the Transporter's 4′ terms in step 44. The LSP 6 then calculates the Shipper rate in step 45 and prepares and provides the Shipper rate quote to the Shipper 1′ in step 46. The LSP 6 and the Shipper 1′ then negotiate terms and interfaces in step 47. In step 48, the LSP 6 again undertakes an analysis of the process to determine whether to proceed. If the LSP 6 decides to proceed in step 49, then the LSP 6 and the Shipper 1′ execute the shipper contract in step 50. The shipper contract executed in step 50 includes, among other terms, the freight and financial rates, shipment constraints and Consignee 2′ credit limits. In step 51, the LSP 6 then sends the Funding Bank 11 and the Performance Insurer 12 the Consignee 2′ details. The LSP 6 then enters into the transporter contract with the Transporter 4′ in step 52 on behalf of the Shipper 1′. However, should the LSP 6 decide not to proceed, then the LSP 6 informs the Shipper 1′ and provides the Shipper 1′ with details of the unsuitability in steps 53 and 54.

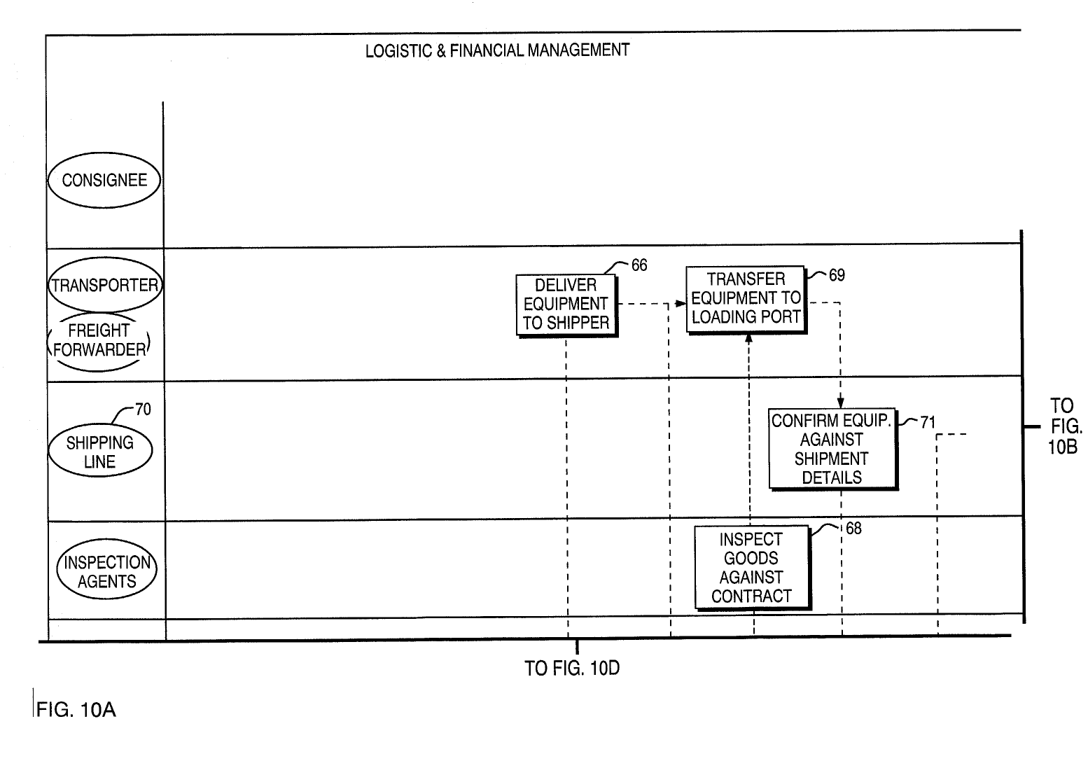

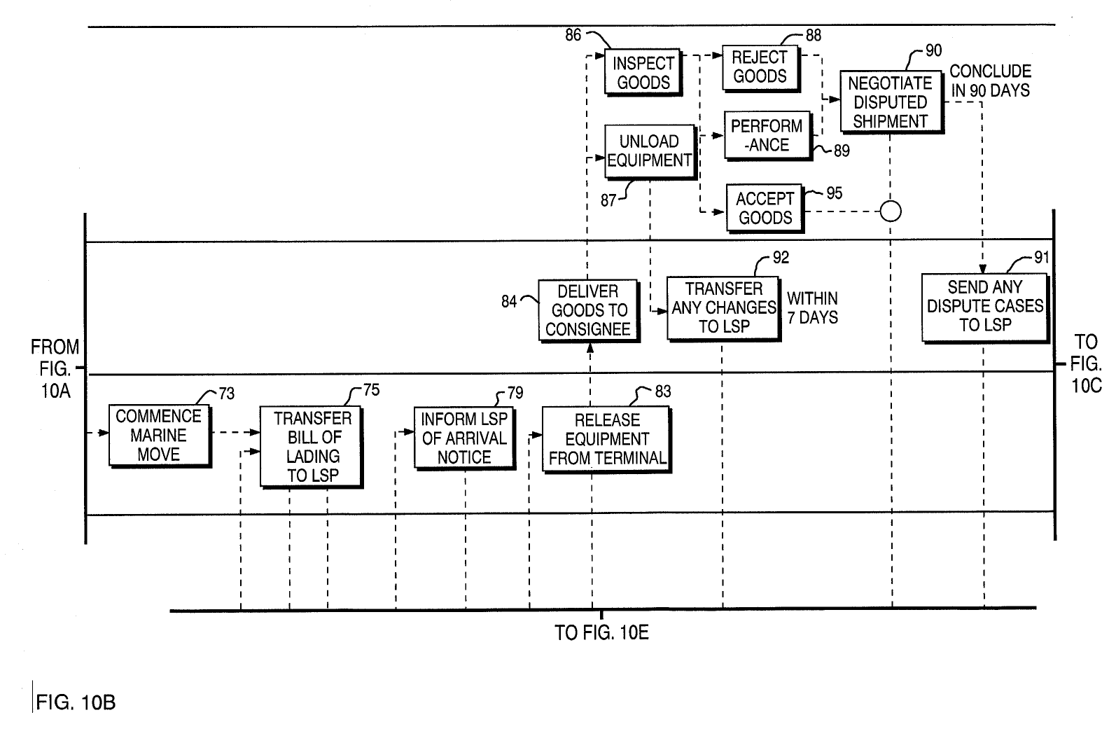

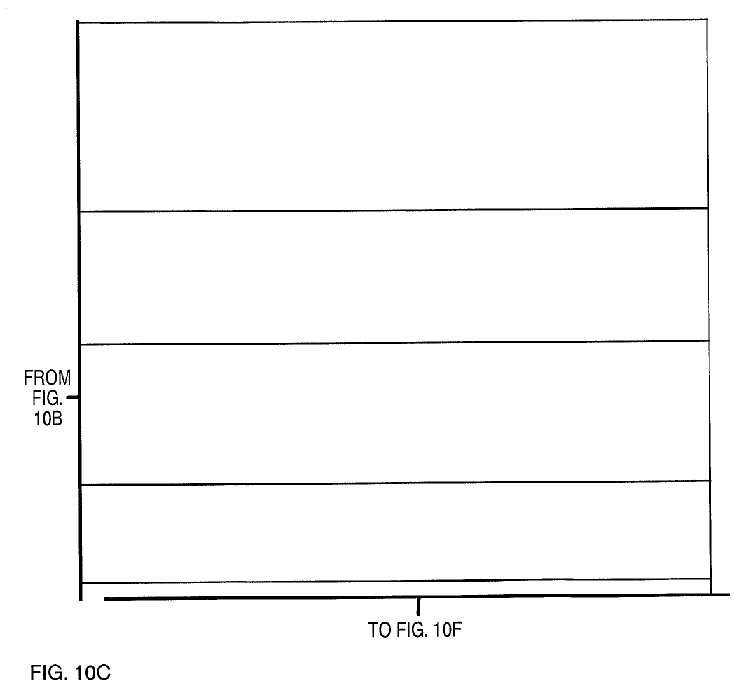

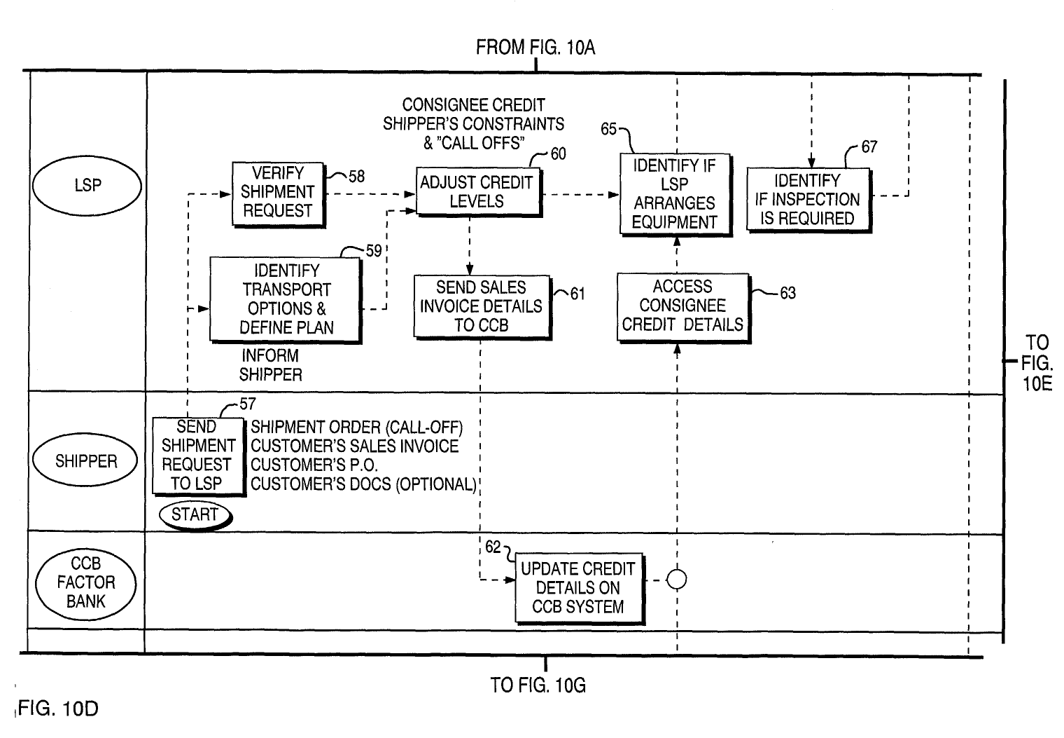

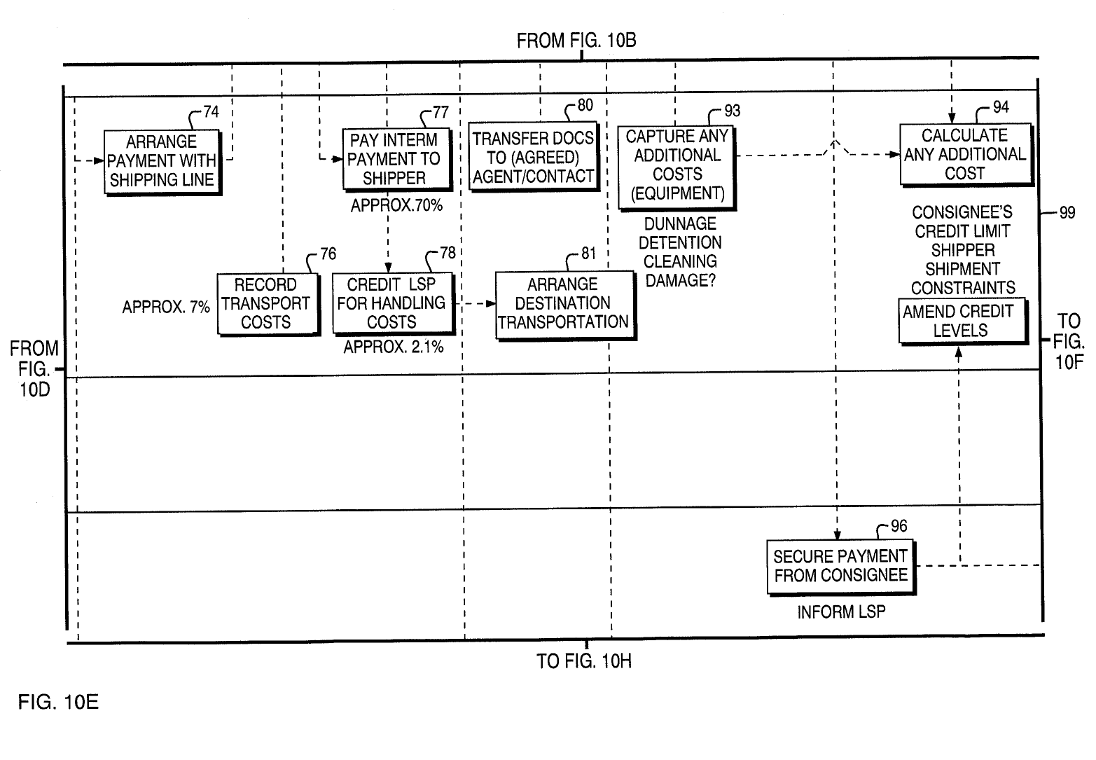

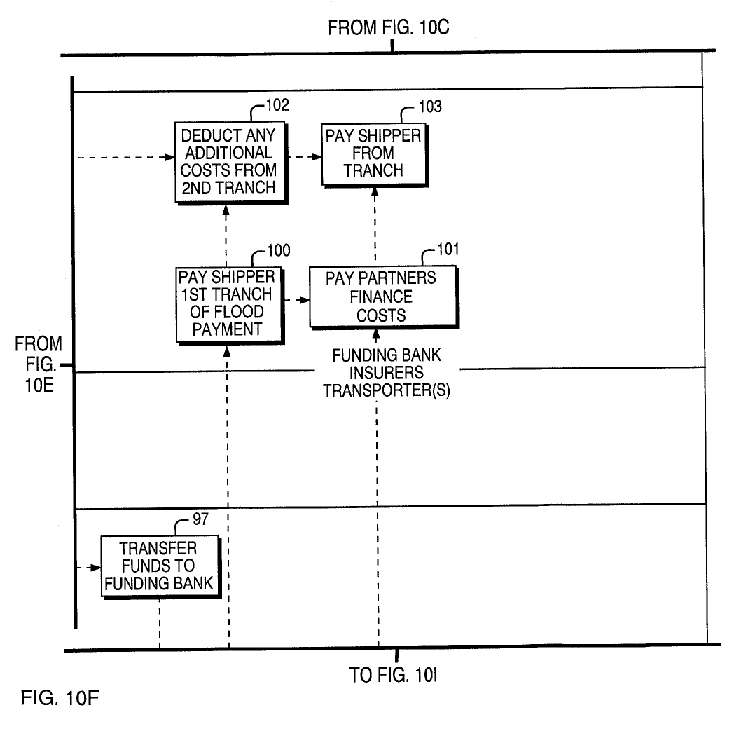

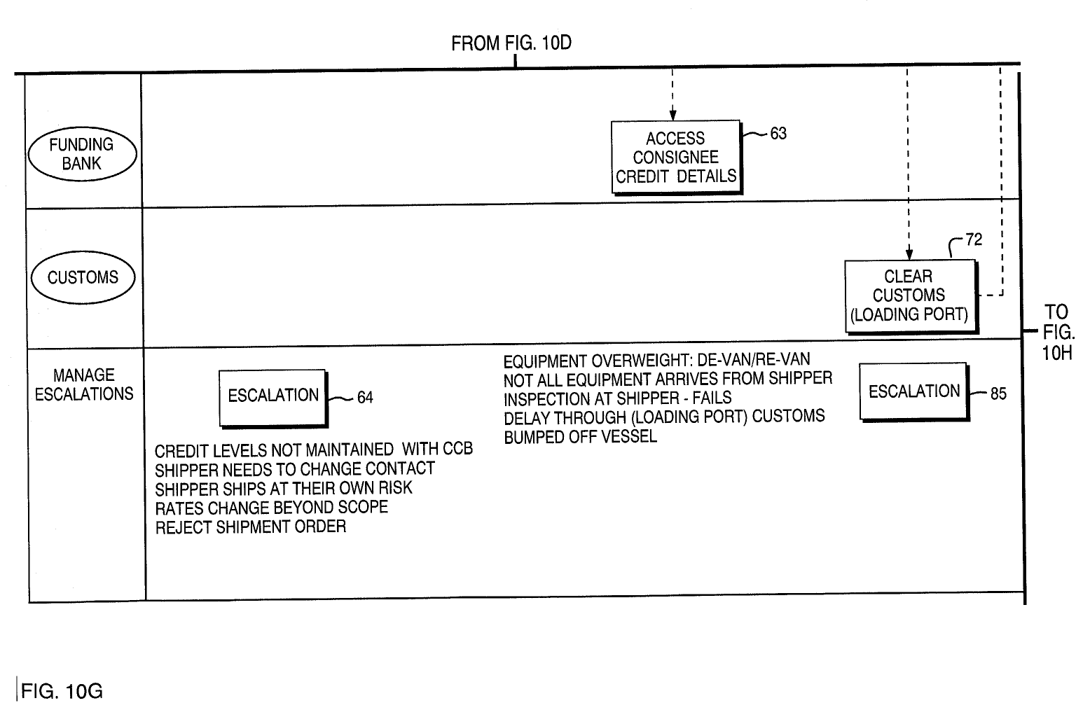

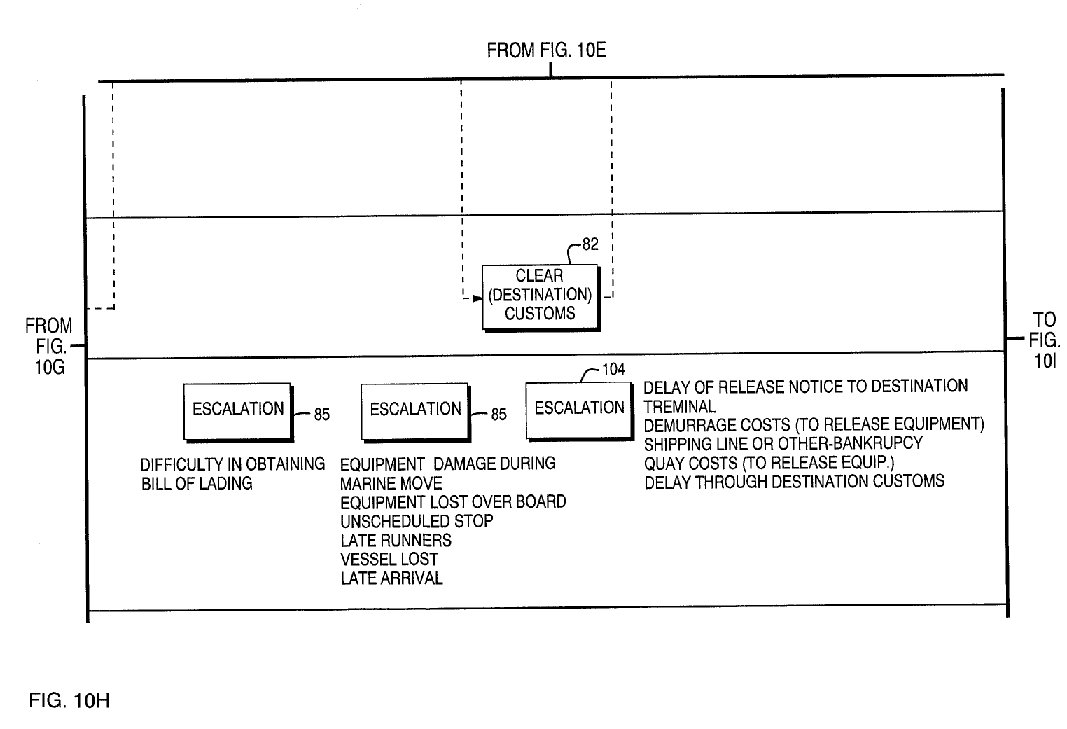

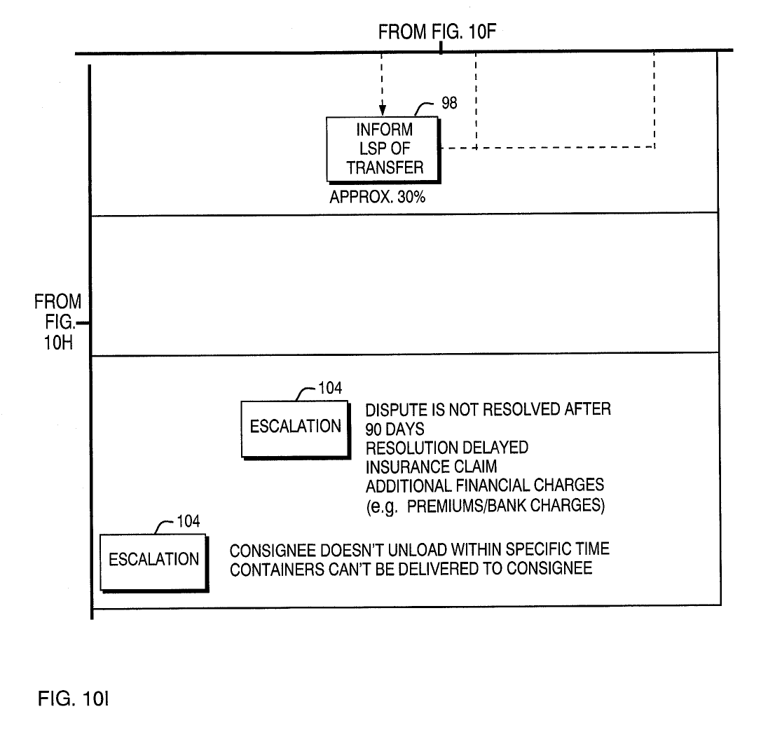

FIGS. 10A-10I are a process flow diagram showing the logistical and financial management steps used for implementing an embodiment of the present invention. In step 57, the Shipper 1′ sends the shipment request to the LSP 6. The LSP 6 then verifies the shipment request and identifies transport options in steps 58 and 59. The shipment request made in step 57 may include, among other items, the shipment order, the customer sales invoice, the customers purchase order and customs documentation.

In step 60, the LSP 6 then reviews the Consignee 2′ credit level and the Shippers 1′ constraints and determines if any adjustments to credit levels are necessary. The LSP 6 then sends the sales invoice details to the Collateral Control Bank 5, and the Collateral Control Bank 5 updates the relevant credit details on the its system in steps 61 and 62. Once updated on the Collateral Control Bank 5 system in step 62, the LSP 6 and the Funding Bank 11 then access the Consignee 2′ credit details in step 63.

If, during this initial phase of the logistical and financial process problems arise, the LSP 6 manages the escalation of negotiations between the parties to resolve such issues in step 64. Such issues may include, credit levels not maintained with the Collateral Control Bank 5, the Shippers 1′ need to change a contract, rates that change beyond the scope agreed upon, or the rejection of a shipment order.

In steps 65 and 66, the LSP 6 determines whether the LSP will be responsible for the delivery of any equipment, and, if so, delivers such equipment to the Shipper 1′. In addition, the LSP 6 determines whether an inspection of the equipment is required in step 67, and if necessary has the goods inspected against the contract by the appropriate inspection agent in step 68. In steps 69 and 71, the Transporter 4′ transfers the equipment to a loading port and the shipping line 70 confirms the equipment against the shipment details.

Once the equipment clears customs at the load port in step 72, the shipping line 70 can commence moving the equipment via marine transport in step 73. At the same time, in step 74 the LSP 6 arranges for payment to be made with the shipping line 70. Upon such payment, the shipping line 70 then transfers the bill of lading to the LSP 6 in step 75. The LSP 6 then records the transport costs in step 76. Additionally, in steps 77 and 78, upon payment to the Shipper 1′ the LSP 6 receives a credit for the handling costs. Upon arrival of the equipment at its destination, the shipping line 70 informs the LSP 6 of the arrival in step 79 and the LSP 6 transfers the appropriate documentation to the appropriate agent or contact and arranges destination transportation for the equipment in steps 80 and 81. In step 82, the equipment is cleared through customs at the destination. Once the equipment has been released from the terminal in step 83, the Transporter 4′ delivers the goods to the Consignee 2′ in step 84.

During the shipping process, the LSP 6 may need to oversee the resolution of problems between the parties as seen in step 85. Such shipping problems may include, among others, an incomplete inventory of equipment, failure of the equipment at the various inspections including customs inspections, delays through the loading port and the customs process, difficulty in obtaining a bill of lading, equipment damage during the marine move, equipment lost overboard, unscheduled stops, late arrivals and lost vessels.

Upon receipt of the equipment, the Consignee 2′ in step 86 unloads the equipment and in step 87 inspects the goods. If the Consignee 2′ rejects the goods in step 88 or has performance issues in step 89, the Consignee 2′ in step 90 will negotiate via the LSP 6 to resolve any disputed issues. Any costs that Consignee 2′ disputes with the Transporter 4′ are sent to the LSP 6 in step 91. Additionally, the Transporter 4′ may transfer other charges in step 92 to the LSP 6, and the LSP 6 may capture additional costs in step 93, including costs related to demurrage, detention, cleaning or damage. The additional costs identified in steps 91 and 93 are then combined by the LSP 6 to calculate the total additional costs in step 94.

If, however, the Consignee 2′ accepts the goods in step 95, the Collateral Control Bank 5 secures payment from the Consignee 2′ and informs the LSP 6 in step 96. The Collateral Control Bank 5 then transfers the funds in step 97 to the Funding Bank 11 and the Funding Bank 11 informs the LSP 6 of the transfer in step 98. The payment made in step 96 by the Consignee 2′ will also cause the LSP 6 to amend the Consignee's 2 credit levels in step 99.

Upon notification by the Funding Bank 11 in step 98 of the transfer of funds made in step 97, the LSP 6 will pay the Shipper 1′ the first tranche of the final payment in step 100. The LSP 6 will also pay the partners finance cost in step 101, including, payments to the Funding Bank 11, and the Performance Insurers 12. Additionally, if the LSP 6 calculates any additional costs in step 94, such additional costs are deducted from the second tranche in step 102 and the Shipper 1′ is then paid the final tranche in step 103.

During the delivery and payment phase of the logistical and financial process outlined above, the LSP 6 may need to undertake and manage negotiations between the parties in step 104, when issues arise out of this phase. Such issues may include delays of the release of the equipment, delays related to customs processing, insurance claims, additional finance charges, and problems or failures with delivery of the equipment to the Consignee 2′.

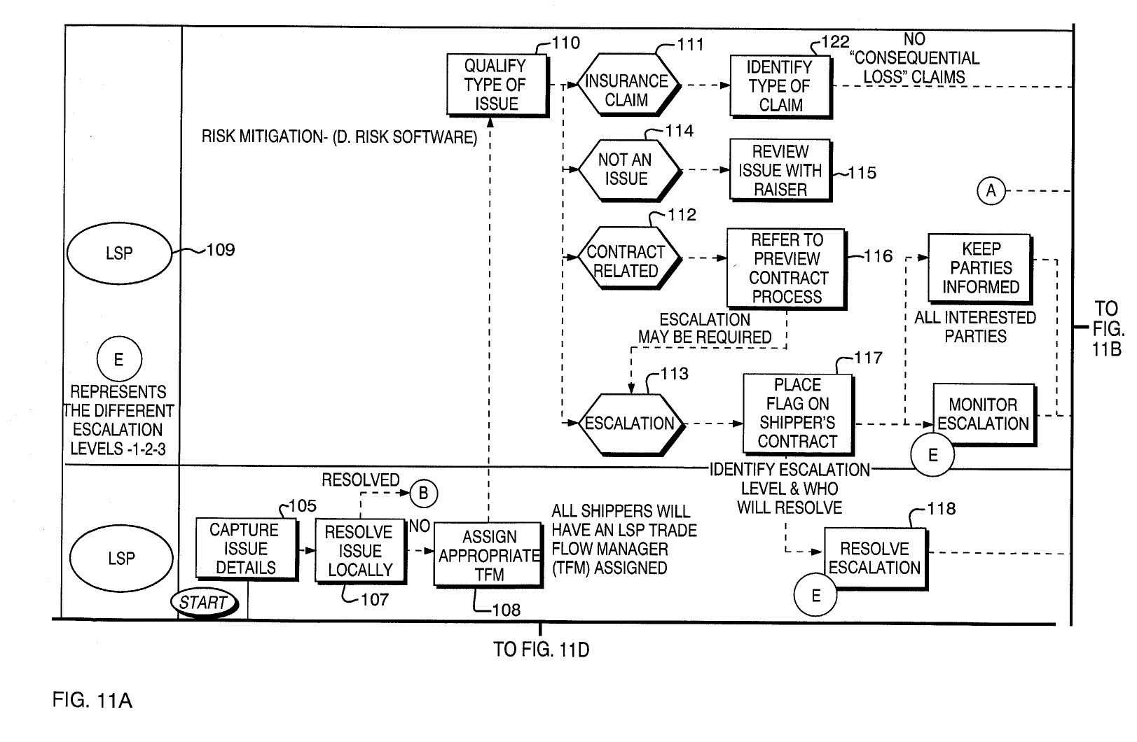

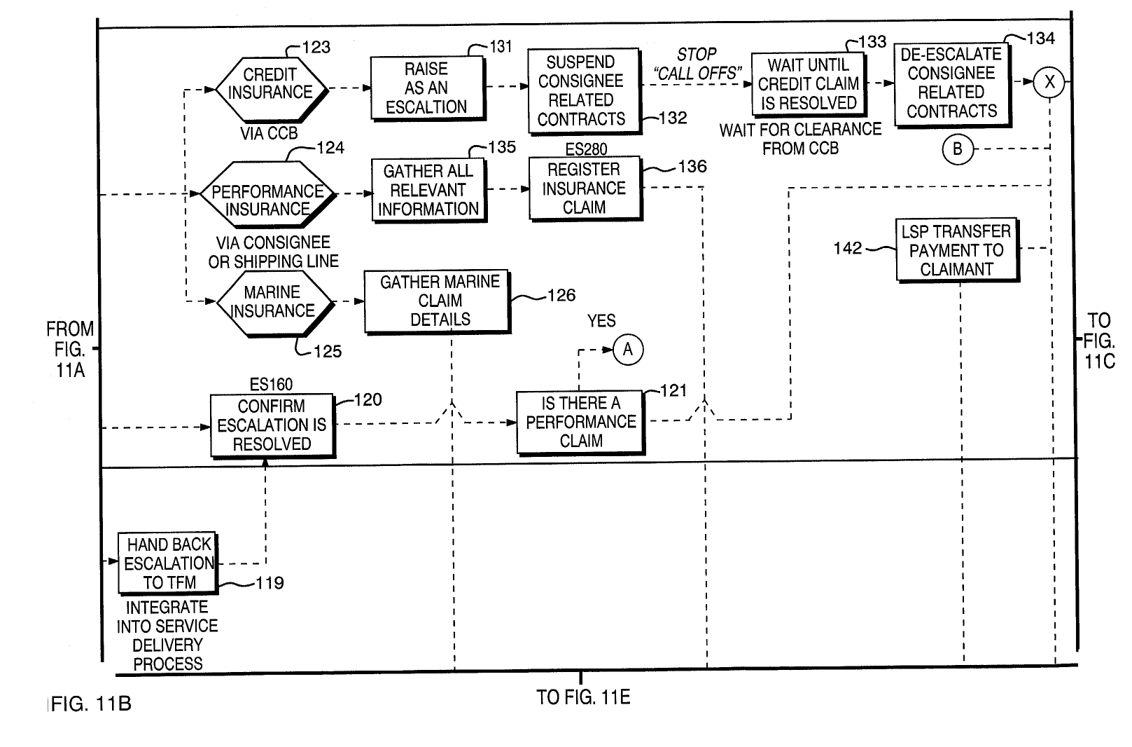

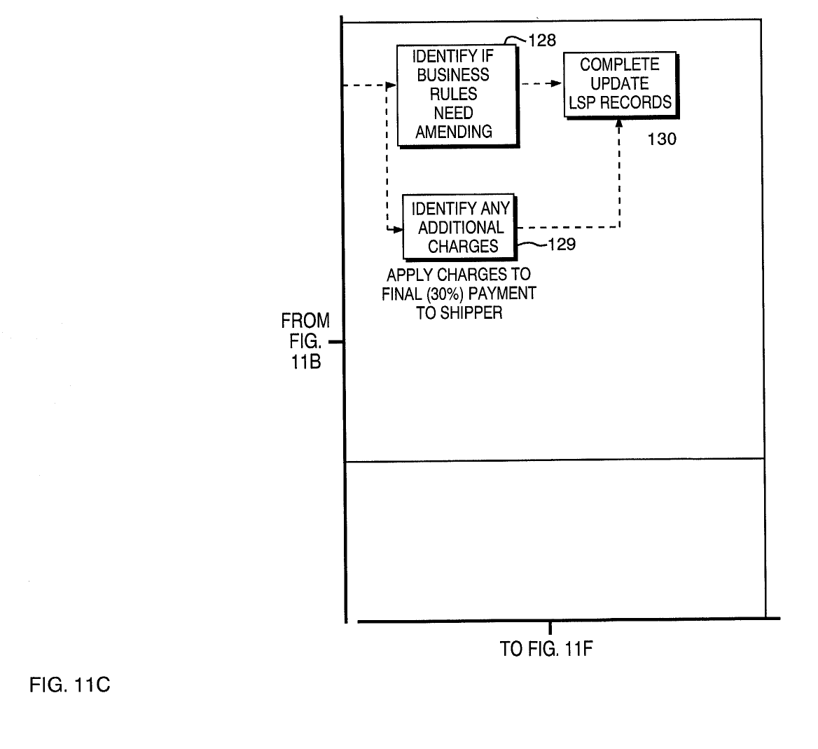

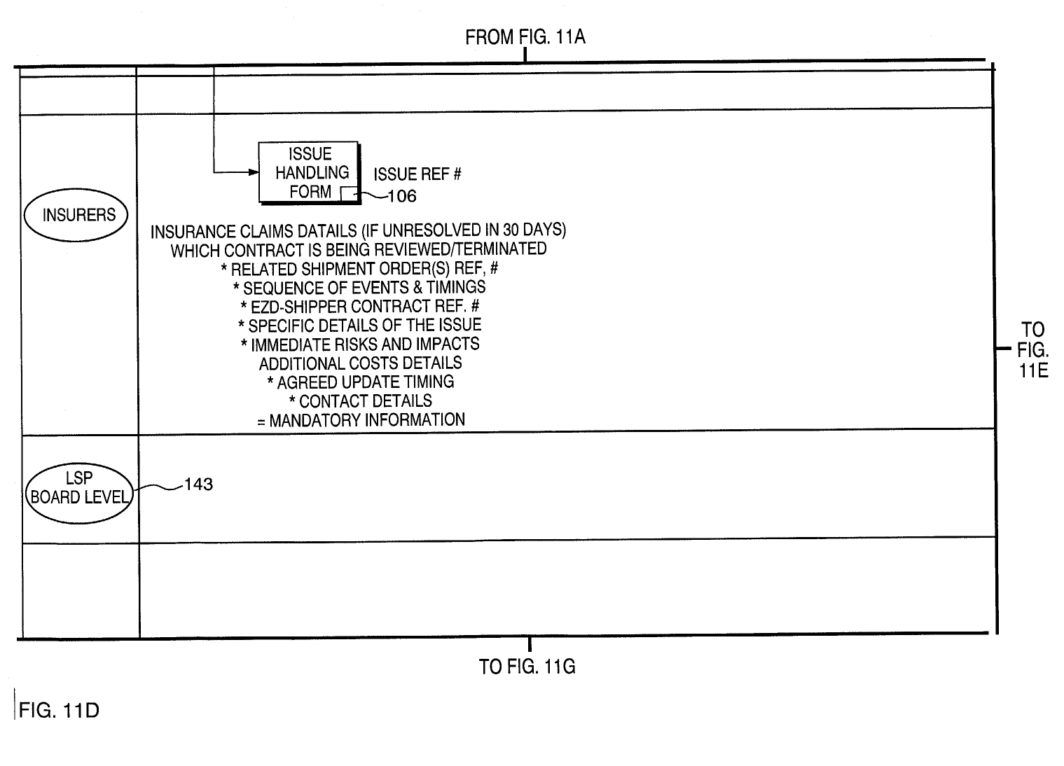

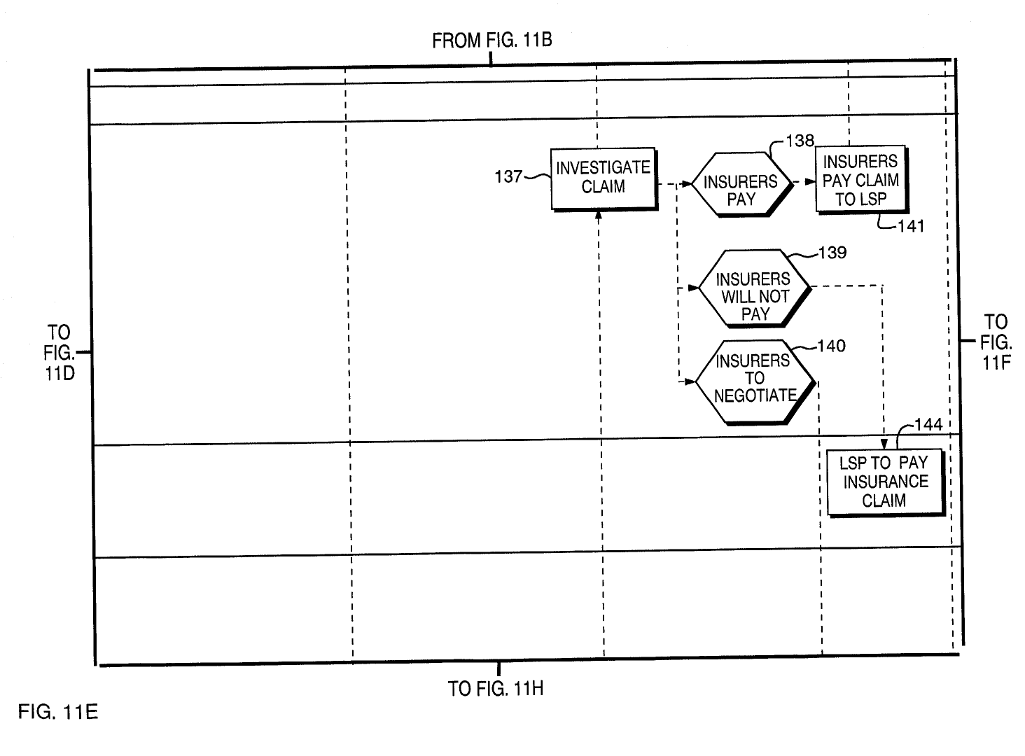

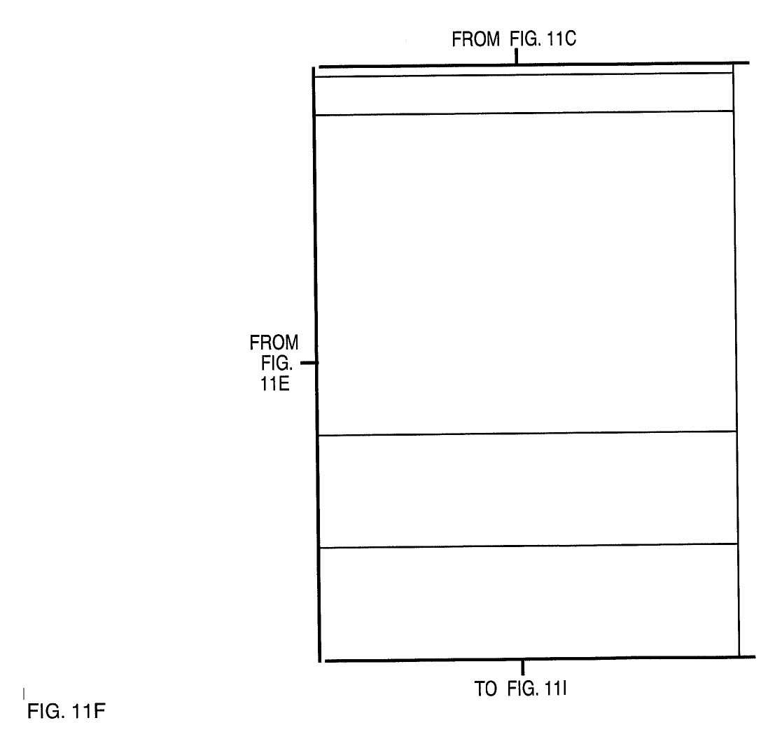

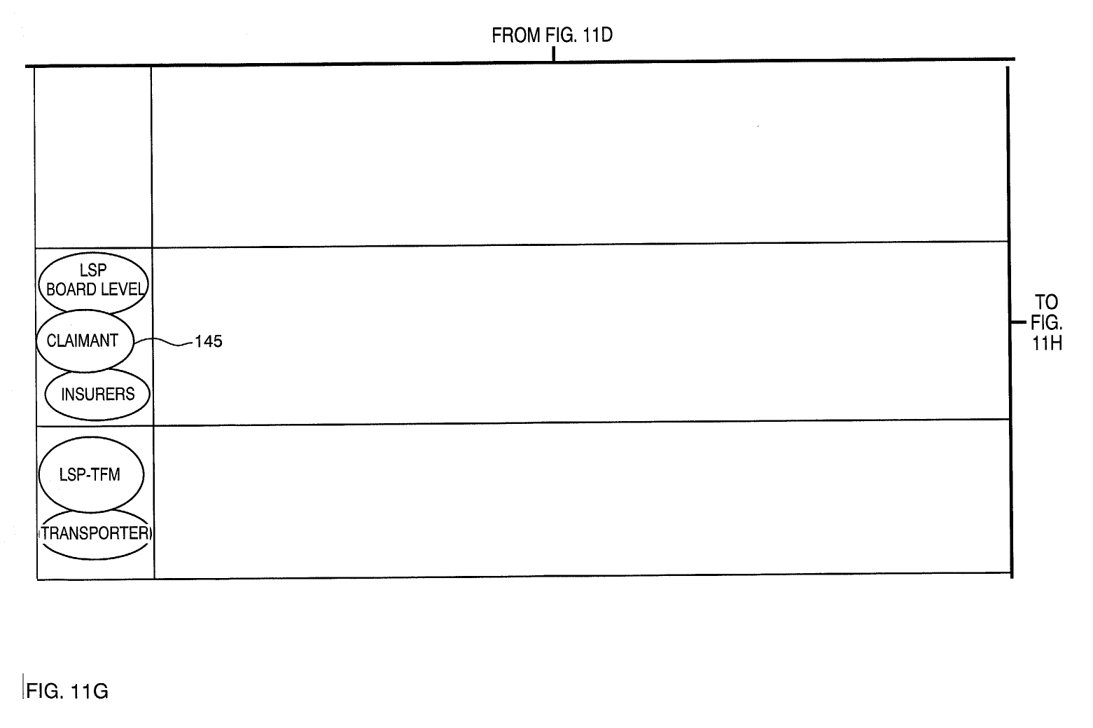

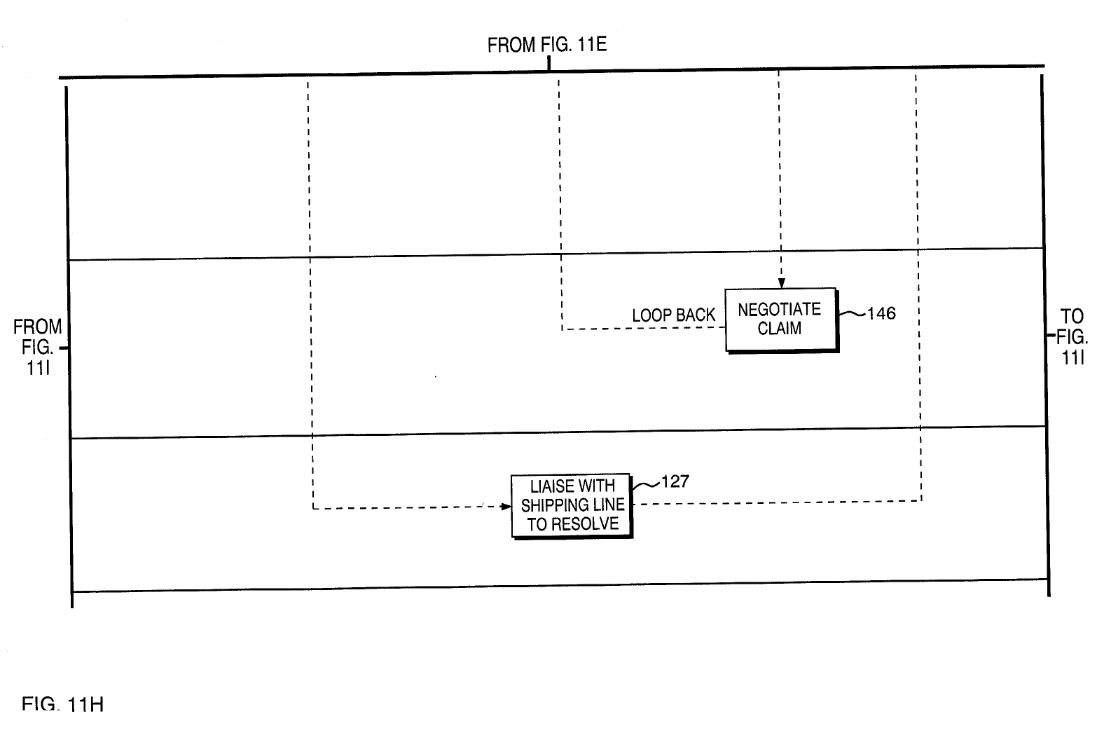

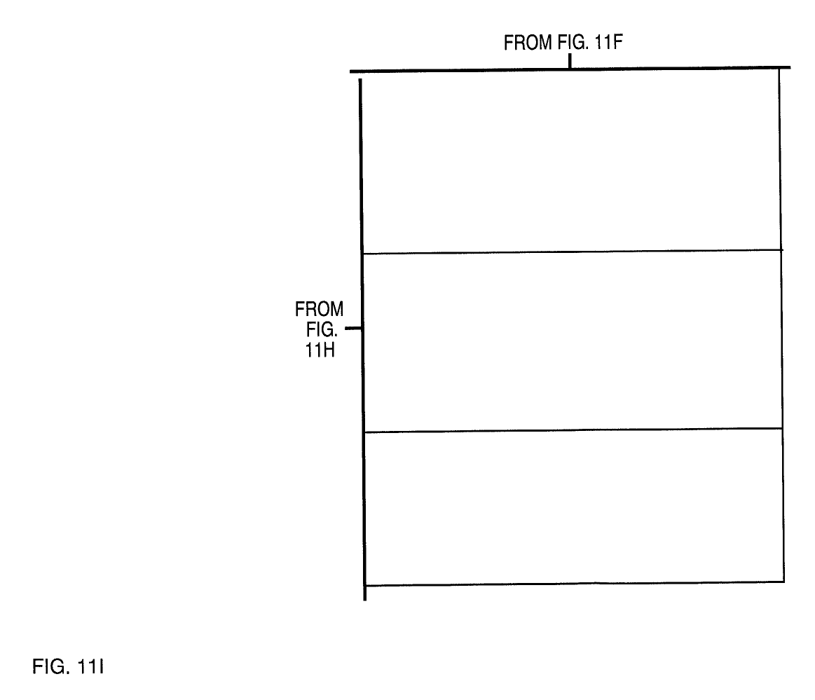

FIGS. 11A-11I are a process flow diagram showing the steps used to mitigate risk when implementing an embodiment of the present invention. In step 105, the processes for evaluating, handling and mitigating risk begins with the LSP 6 capturing the issues and risk details. The LSP 6 creates an issue handling form in step 106. The issue handling form of step 106 includes, among other things, claim details, information related to the contract being reviewed or terminated, the shipment orders at issue, the sequence of events and timing at issue, the LSP 6-Shipper 1′ contract reference number, specific details of the issue, the immediate risks and impacts, details about any additional costs, agreed upon timing for updates, and appropriate contact details.

Upon the LSP's 6 capture of the issues and risks in step 105, the LSP 6 may seek to resolve the issue locally in step 107. In step 108, the LSP 6 will assign the appropriate trade flow manager (TFM) 109 to assist in resolving the issues and managing the process. Each Shipper 1′ is assigned a specific TFM 109 by the LSP 6. The TFM 109 qualifies the type of issue in question in step 110. The type of issue may be an insurance claim (step 111), a contract related issue (step 112), an escalation of negotiations (step 113), or may not be an issue at all (step 114).

If the TFM 109 qualifies the issue in step 110 as not being an issue at all (step 114), the TFM 109 will then review the issue with the individual or entity who raised the issue in step 115.

If the TFM 109 qualifies the issue in step 110 as a contract related issue (step 112), the TFM 109 will refer to the contract for the appropriate review process in step 116. If the TFM 109 is unable to resolve the issue based on the contract review in step 116, an escalation of negotiations may be required (step 113).

If the TFM 109 qualifies the type of issue in step 110 as an escalation (step 113), the TFM 109 will place an escalation flag on the Shipper 1′ contract in step 117 which identifies the escalation level and the party or parties who will resolve the escalation. The TFM 109 may then refer the escalation to the LSP 6 for resolution in step 118. Upon resolution, the LSP 6 will hand back the escalation in step 119 to the TFM 109 for integration into the service delivery process. The TFM 109 will then confirm that the escalation has been resolved in step 120. If, in step 120, the TFM 109 determines upon confirmation that the escalation has been resolved, and that there exists a performance claim, in step 121 the performance claim will be resolved via the appropriate process outlined below.

If the TFM 109 qualifies the type of issue in step 110 as an insurance claim (step 111), the TFM 109 will identify the type of claim in step 122 as either being a credit insurance claim (step 123), a performance insurance claim (step 124), or a marine insurance claim (step 125). If the type of claim identified in step 122 is a marine insurance claim (step 125), then the TFM 109 will gather details related to the marine claim in step 126 and will liase with the shipping line 70 and/or the transporter 4′ to resolve the claim in step 127. Upon resolution of the marine claim (step 125), the TFM 109 will identify in step 128 whether any business rules of the LSP 6 need amending, will determine in step 129 whether any additional charges apply and will complete an update of the LSP 6 records in step 130.

If the TFM 109 identifies the type of claim in step 122 as a credit insurance claim (step 123), then the TFM 109 will raise the claim as an escalation in step 131 and will suspend all Consignee 2′ related contracts in step 132. Credit insurance claims (step 123) are instituted via the Collateral Control Bank 5 and the applicable Consignee 2′ related contracts are held until the claim is resolved by way of clearance from the Collateral Control Bank 5 in step 133. Upon clearance from the Collateral Control Bank 5 in step 133, the TFM 109 de-escalates the Consignee 2′ related contracts in step 134. Once the Consignee 2′ related contracts have been de-escalated in step 134, the TFM 109 identifies in steps 128 and 129 whether any of the LSP's 6 business rules need amending or whether any additional charges apply. The TFM 109 then completes an update of the LSP 6 records in step 130.

If the TFM 109 identifies the type of claim in step 122 as a performance claim (step 124), the TFM 109 will gather all the relevant information and will register an insurance claim in steps 135 and 136. In steps 137 through 140, the Performance Insurer 12 will investigate the claim and determine whether the Performance Insurer 12 will or will not pay the claim, or whether the Performance Insurer 12 will negotiate with the relevant parties to resolve the claim. If the Performance Insurer 12, in step 138, agrees to pay the claim, payment is made in step 141 to the LSP 6. The TFM 109 of the LSP 6 then transfers the payment to the claimant in step 142. Upon transfer of the payment, the TFM 109 will identify in step 128 whether any business rules of the LSP 6 need amending, will determine in step 129 whether any additional charges apply and will complete an update of the LSP 6 records in step 130.

If upon investigation of the claim in step 137, the Performance Insurers 12 determine in step 139 that they will not pay the claim, then LSP 6 personnel at the board level 143 will determine in step 144 whether the LSP 6 will pay the insurance claim. Upon payment of the claim in step 144 by the LSP 6, the TFM 109 will identify in step 128 whether any business rules of the LSP 6 need amending, will determine in step 129 whether any additional charges apply and will complete an update of the LSP 6 records in step 130.

If the Performance Insurers 12 after investigation of the claim in step 137 determine that they are willing to negotiate the claim (step 140), the LSP 6 board level personnel 143, the Performance Insurers 12 and the claimant 145 will meet to negotiate the claim in step 146. Negotiation of the claim in step 146 may result in the need for additional investigation of the claim in step 137. Upon completion of the negotiation in step 146 and any additional investigation in step 137, the Performance Insurer 12, in steps 138 and 139, will make a final determination whether they will or will not pay the claim. Should the Performance Insurer 12 determine in step 138 that payment will be made, the Performance Insurer 12 will pay the claim in step 141 to the LSP 6 and the TFM 109 of the LSP 6 will transfer the payment in step 142 to the claimant 145. Should the Performance Insurer 12 determine in step 139 that it will not pay the claim, then the LSP 6 board level members 143 will determine whether the LSP 6 will pay the insurance claim in step 144. In either case, the TFM 109 will, upon resolution of the negotiated insurance claim, identify in step 128 whether any business rules of the LSP 6 need amending, determine in step 129 whether any additional charges apply, and complete an update of the LSP 6 records in step 130.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately, or in any suitable combination.

It is to be recognised that various alterations, modifications, and/or additions may be introduced into the constructions and arrangements of parts described above without departing from the spirit or ambit of the present invention.

The embodiments described above are intended to provide a preferred embodiment of the present invention as currently contemplated by the applicant. It would be obvious to anyone of skill in the art based on the above-described examples that numerous modifications could be made to the described preferred embodiments. Accordingly, the embodiments described herein are merely exemplary in nature and are not intended to represent every possible embodiment of the present invention.

What is claimed:

1. A method for facilitating non-recourse funding of trade in goods during transit from a Shipper to a Consignee, wherein a Funding Bank obtains performance insurance from a Performance Insurer covering risks associated with non-performance of the Shipper under a trade contract associated with the goods, wherein the Funding Bank advances at least a portion of payments due to the Shipper under the trade contract without recourse to the Shipper upon dispatch of the goods from the Shipper based on a commitment from a Collateral Control Bank, and wherein a Transporter of the goods under the trade contract surrenders any security interest acquired in the goods during transit, said method comprising:
issuing, from the Collateral Control Bank, a commitment to provide credit protection to the Funding Bank to cover risks associated with non-payment by the Consignee of amounts due under the trade contract upon receipt of the goods by the Consignee.

2. A method for facilitating non-recourse funding of trade in goods during transit from a Shipper to a Consignee, wherein a Funding Bank obtains performance insurance from a Performance Insurer covering risks associated with non-performance of the Shipper under a trade contract associated with the goods, wherein a Collateral Control Bank issues a commitment to provide credit protection to the Funding Bank to cover risks associated with non-payment by the Consignee of amounts due under the trade contract upon receipt of the goods by the Consignee, and wherein the Funding Bank advances at least a portion of payments due to the Shipper under the trade contract without recourse to the Shipper upon dispatch of the goods from the Shipper based on the performance insurance and the commitment from the Collateral Control Bank, said method comprising:
delivering the goods to the Consignee using a Transporter that has surrendered any security interest acquired in the goods during transit.

3. A method for facilitating non recourse funding of trade in goods during transit from a Shipper to a Consignee, comprising the steps of:
selecting a Funding Bank, a Collateral Control Bank, a Performance Insurer and a Transporter;
obtaining a commitment from the Collateral Control Bank for credit protection;
collecting payments due from the Consignee according to agreed payment terms;
obtaining a commitment from the Transporter to surrender any security interest in the goods during transport;
obtaining a commitment from the Performance Insurer for performance insurance of the Shipper, in the case of a dispute under a trade contract,; and
obtaining a commitment from the Funding Bank to provide funds for any payments due under the trade contract, without recourse to the Shipper, based on respective commitments obtained from the Collateral Control Bank, Performance Insurer and Transporter.

4. A method according to claim 3, in which the Collateral Control Bank collects the payments due from the Consignee on agreed credit terms.

5. A method according to claim 3 further comprising the step of making payments to the Shipper, on an agreed schedule, on confirmed dispatch of the goods.

6. A method according to claim 3, further comprising the step of arranging, monitoring and managing the steps needed to complete the trade transaction to ensure limitation of risk.

7. A method according to claim 3, in which the transport contract comprises a bill of lading, and in which a security interest in title to the goods is implemented by obtaining constructive control of the bill of lading.

8. A method according to claim 6, further comprising the step of receiving data from an electronic tagging system relating to movement history of the goods and trading history of Shipper and Consignee.

9. A method according to claim 3,-in which the Funding Bank is named as a beneficial party of the credit protection relating to the trade contract provided by the Collateral Control Bank.

10. A method according to claim 3, in which the Funding Bank is named as the beneficial party of the performance insurance provided by the Performance Insurer.

11. A computer system for facilitating trade in goods during transit from a Shipper to a Consignee, comprising: at least one communications network coupled to at least one logistic data server and at least one trade management system, wherein the communications network couples a plurality of data terminals that transmit and receive data from parties involved in the funding of trade in goods during transit from a Shipper to a Consignee, wherein the logistic data server stores, processes and accesses data received from the data terminals, wherein the logistic data server calculates a target shipping scheduling trajectory for transit of goods from the Shipper to the Consignee based on a planned movement of the goods, wherein the trade management system monitors an actual shipping trajectory of the goods during transit from the Shipper to the Consignee, wherein the trade management system determines whether to initiate corrective action to alter the planned movement of the goods when the actual shipping trajectory differs from the target shipping trajectory by more than a predetermined amount, and wherein the trade management system determines whether to alter the planned movement of the goods based at least in part on a financial risk that will be borne by at least one of the Shipper, the Consignee, a Performance Insurer, a Logistics Service Provider, a Collateral Control Bank or a Funding Bank as a result of delay in shipment of the goods if the planned movement of the goods is not altered.

12. The computer system of claim 11, wherein the logistic data server is capable of monitoring the integrity of the chain of contracts between the parties.

13. The computer system of claim 11, wherein the logistic data server is capable of transmitting and receiving contracts related to the funding of trade in goods through the communications network.

14. A method for using a computer system to facilitate trade in goods during transit from a Shipper to a Consignee, comprising the steps of:
(a) coupling at least one communications network to at least one logistic data server and at least one trade management system;
(b) coupling the communications network to a plurality of data terminals that transmit and receive data from parties involved in the non-recourse funding of trade in goods during transit from a Shipper to a Consignee;
(c) accessing, processing and storing on the logistic data server, data received from the data terminals;
(d) calculating, with the logistic data server, a target shipping scheduling trajectory for transit of goods from the Shipper to the Consignee based on a planned movement of the goods;
(e) monitoring, with the trade management system, an actual shipping trajectory of the goods during transit from the Shipper to the Consignee;
(f) determining, with the trade management system, whether to initiate corrective action to alter the planned movement of the goods when the actual shipping trajectory differs from the target shipping trajectory by more than a predetermined amount; and
(g) determining, with the trade management system, whether to alter the planned movement of the goods based at least in part on a financial risk that will be borne by at least one of the Shipper, the Consignee, a Performance Insurer, a Logistics Service Provider, a Collateral Control Bank or a Funding Bank, as a result of delay in shipment of the goods if the planned movement of the goods is not altered.

15. The method of claim 14, wherein the logistic data server monitors the integrity of the chain of contracts between the parties.

16. The method of claim 14, wherein the logistic data server transmits and receives contracts related to the funding of trade in goods through the communications network.
